(19) United States
(12) Patent Application Publication
(10) Pub. No.: US 2003/0051164 A1
(43) Pub. Date: Mar. 13, 2003

(54) System and method for authentication of network users with preprocessing generating a verified personal profile for use on a publicly accessed global networked computer system and a system and method for producing the exchange of such secure identification

(76) Inventor: Patricia Carol Patton, New Port Richey, FL (US)

Correspondence Address: Patricia C. Patton, 8416 Liman Drive, New Port Richey, FL, 34653, US

(21) Appl. No.: 10/139,446

(22) Filed: May 6, 2002

Related U.S. Application Data
(60) Provisional application No. 60/292,055, filed on May 18, 2001.

(51) Int. Cl. G06F 12/14; G06F 11/30; H04L 9/32; H04L 9/00

(52) U.S. Cl. 713/201

(57) ABSTRACT

The present invention relates to a web-based interactive system and method whereby a user may generate an accurate personal profile, which is authenticated and verified by a gateway computer system, that may be shared with other users and websites desirous of ensuring the accuracy of the personal profile of the user to verify identities, conduct a transaction, access data or avail themselves of other resources or processing. A system and method for producing the exchange of such secure identification, a VPP (Verified Personal Profile). In one embodiment the users unique identification information, locator code, which may be encrypted, is stored on an identification CD (Compact Disk) and validated to permit access to the network computer.

### CROSS-REFERENCE TO RELATED APPLICATIONS

The present invention claims priority from co-pending U.S. Provisional Patent Application Ser. No. 60/292,055 filed on May 18, 2001, titled; “Personal Profile Generation and Verification System and Method” the disclosure of which is incorporated herein in its entirety for all purposes.

### FIELD OF THE INVENTION

The present invention relates to a system and method for generating and exchanging a verified personal profile for use on a publicly accessed global networked computer system. More specifically, the present invention relates to a web-based interactive system and method whereby a user may generate and exchange an accurate personal profile that may be shared with other users and websites desirous of ensuring the accuracy of the profile of the user.

### BACKGROUND OF THE INVENTION

The introduction and accelerating use of publicly accessible, packet-switched, distributed network environments such as the Internet has resulted in an explosion of both the quantity and availability of personal and commercial information thereon. It is common for one computer operator to obtain information offered and transmitted by another computer operator over the network. However, since the Internet is largely unregulated, there is no assurance that all this information is accurate or reliable, and often the source of the data is not even ascertainable. For example, in an Internet chat room or other interactive networked environment, personal profiles may be accessed purporting to describe the person with whom one is interacting. The personal profile of the other person is authored by that person and may include unreliable information. Therefore, when a user thinks he or she is talking to a thirty five year old woman, in reality it may be a seventy two year old man.

There exists a growing interest in society to provide security, rules and regulations to prevent online deception. Interest exists for example in parents who want to protect their young daughter from cyber-stalking or exploitation by an older man. People in gay chat rooms are interested in making sure they are at least talking to the same gender. Pornographic and gambling sites are interested in verifying a user or subscriber's age. Additionally, unless particular precautions are taken, anything sent via the Internet is subject to interception and misuse.

Identity theft has become a serious threat to society. Criminals steal identities to avoid being held accountable for their actions. One individual could realistically have access to numerous identities. At this time, there is no one universal cross checking system that assures one identity per individual.

The security of commercial information for transactions conducted via the Internet is also factor affecting the growth of electronic commerce. This concern stems in part from the difficulty of providing verification and accountability via the Internet. It is easy for legitimate and illegitimate businesses alike to set up websites to solicit business over the Internet. Accordingly, there is a degree of uncertainty about the identity and legitimacy of any business offering goods or services via an Internet web page and about the authenticity of data related to online transactions. Therefore, customers are wary about purchasing goods or services and sending confidential information such as credit card numbers to Internet based businesses without a degree of certainty as to the authenticity and legitimacy of an Internet merchant. Thus, there is a need to provide a global network (Internet) utility or tool for promoting the exchange, security and authenticity of personal and commercial information.

It would therefore be desirable to provide a service that overcomes these and other problems associated with computer users of these global networks wanting to create authentic and verifiable personal and commercial profiles.

It would also be desirable for one computer operator obtaining information offered and transmitted by another computer operator over the network to have the ability to assure that the information is from an authentic source.

It would also be desirable for a computer operator to be able to offer to another computer operator personal or commercial information that the other computer operator has the ability to assure is from an authentic source.

### SUMMARY OF THE INVENTION

According to a broad aspect of the invention, a system and method for exchange of personal data is provided between pluralities of computer systems over a public communication system, such as the Internet. More specifically, the present invention relates to the system and method for authoring, authentication, exchange and verification of a personal profile. In the preferred embodiment of the invention, users of the system access a secure website using their personal computer at which they may author their profile, which is verified by secure online software. Getting a profile is voluntary on the part of the user. The Level I profile provides at least the person's gender, age and a screen name. A Level II profile is provided that allows the user additional options such as getting a photo or sharing with any particular website their real name and personal information. A Level III profile contains all the users financial information. Group profiles will also be offered.

The present invention provides the Internet society with a tool to establish a sense of security with the identity of Internet users. The agent based system collects user provided information and verifies the information to create an authentic personal profile to ensure accurate user identification in a networked computer environment. The system obtains input text in character form relating to personal infonnation about the Internet user, such as the users social security number (or equivalent in other countries), and related information in order to create the profile. Software (SSN cross checking program) ensures that the information provided is accurate. The information is then processed and if approved, the user is assigned a personal profile. The user is then provided with a (burn safe, read only) CD, or disk (as needed), the size of a business card (or other secure storage device) that will contain relevant information and their secure access code. An access program is provided to interactive websites to retrieve personal profiles. Partnering websites that want to use profiles for their users will use compatible software to connect them to the profile website to retrieve profiles.

The profile website may increase its functionality through sharing and augmenting of functions through partnering with or outsourcing to other companies. Revenue through the website may be generated through profile fees, sponsorships, partnerships, and development of compatible software and data. Initial interest will come from parents who want to prevent exploitation of their children. Chat rooms can use the invention to make sure they are at least talking to the age and gender of person they prefer. Pornographic and gambling sites can use the invention to ensure the age and gender of a user or subscriber. This will create a grass roots movement among conscientious, responsible users and websites to require verified personal profiles.

Accordingly, it is a primary object of the present invention to provide a service that interacts with personal and commercial computer users of global networks to create authentic and verifiable profiles.

It is a another object of the present invention to provide a service of the character described wherein such a profile would include a computer users gender, age and a screen name.

It is a another object of the present invention to provide a service of the character described wherein such a profile would include other profile information such as a users home, their real name and other information.

It is a another object of the present invention to provide a service of the character described wherein such profiles of computer users may include other profiles for financial use.

It is a another object of the present invention to provide a service of the character described wherein such a profile would include other profile group information such as a business purchasing department employee identification.

It is a another object of the present invention to provide a service of the character described wherein such a profile may be certified as being from an authentic source and without risking the exposure of the information to interception by third parties that have access to the network.

It is a another object of the present invention to provide a service of the character described using a gateway computer system, which a computer user may use to generate, store and transmit such accurate user profiles.

It is a another object of the present invention to provide a service of the character described wherein the gateway computer system has the responsibility of verifying the accurate profile of other computer users to a first computer user.

It is a another object of the present invention to provide a service of the character described wherein the gateway computer system is authorized by a first computer user and has the responsibility of authenticating the accurate profile of the first computer user to other users and websites on the computer network via the gateway computer system.

It is a another object of the present invention to provide a service of the character described wherein the computer user may authorize a gateway computer system to make data available for access or processing only by those approved by the computer user.

It is a another object of the present invention to provide a service of the character described wherein the gateway computer system receives contractual agreements with partnered interactive websites who agree to use personal profiles only for the stated purpose.

Further objects and advantages of the invention will become apparent from a consideration of the drawings and ensuing description thereof

### BRIEF DESCRIPTION OF THE DRAWINGS

The foregoing and other objects, aspects and advantages are better understood from the following detailed description of a preferred embodiment of the invention with reference to the drawings, in which:

FIG. 1 shows the summary of the invention for the overall process for authoring, authenticating, verifying and exchanging users VPP according to the invention.

FIG. 2 shows exemplary elements available on the gateway computer website in the preferred embodiment of the invention.

FIG. 3 shows the summary of the PPP (Purchase Profile Program) as practiced in the preferred embodiment of the invention.

FIGS. 4A-F is a block diagram of the Purchase Profile Program (PPP) as practiced in the preferred embodiment of the invention;

FIG. 5 is a block diagram of the Database Cross-checking program subroutine of the PPP in accordance with a preferred embodiment;

FIG. 6 is a block diagram of the SSN Misuse subroutine of the PPP in accordance with a preferred embodiment;

FIG. 7 is a block diagram of the Profile Information Verification subroutine of the PPP in accordance with a preferred embodiment;

FIG. 8 is a block diagram of the ID Profile Creation subroutine of the PPP in accordance with a preferred embodiment;

FIG. 9 is a block diagram of the Business Level II Profile Creation subroutine of the PPP in accordance with a preferred embodiment;

FIG. 10 is a block diagram of the Business Level III Profile Creation subroutine of the PPP in accordance with a preferred embodiment;

FIG. 11 is a block diagram showing the connectivity of the exchange of a VPP between the profile database service of the present invention with a user and a partnered website.

FIG. 12 is a block diagram of the Website Interactive Program (WIP) as practiced in the preferred embodiment of the invention;

FIG. 13 is a block diagram of the Redirect subroutine of the WIP in accordance with a preferred embodiment;

FIG. 14 is a block diagram of the Information Sharing subroutine of the WIP in accordance with a preferred embodiment;

FIG. 15 is a block diagram of the Hand Holding subroutine of the WIP in accordance with a preferred embodiment;

FIGS. 16A-B is a block diagram of the Profile Interactive Program (PIP) as practiced in the preferred embodiment of the invention;

FIG. 17 is a block diagram of the ID Profile Retrieval subroutine of the PIP in accordance with a preferred embodiment;

FIG. 18 is a block diagram of the Business Level II Profile Retrieval subroutine of the PIP in accordance with a preferred embodiment;

FIG. 19 is a block diagram of the Business Level II Profile Retrieval subroutine of the PIP in accordance with a preferred embodiment;

FIG. 20 is a block diagram of the CD Interactive Program (CIP) as practiced in the preferred embodiment of the invention;

FIG. 21 is a block diagram of the PC Interactive Program (PCIP) as practiced in the preferred embodiment of the invention;

FIGS. 22A-H shows a list of sample messages and customer service codes cross-referenced to the block diagrams of FIGS. 4A-21.

### DETAILED DESCRIPTION

A method and apparatus for verifying data related to online transactions is described. In the following description, numerous specific details are set forth in order to provide a more thorough description of the invention. It will be apparent, however, to one skilled in the art that the invention may be practiced without these specific details. In other instances, well-known features have not been described in detail so as not to obscure the invention.

A preferred embodiment of a system in accordance with the present invention is preferably practiced in the context of a personal computer (“PC”) such as the IBM PS/2, Apple Macintosh computer or UNIX based workstation, but may also be practiced in the context of a device such as a network computer (“NC”), a personal digital assistant (“PDA”), or an enhanced function telephone, etc. A representative hardware configuration of a PC workstation in accordance with a preferred embodiment having a central processing unit, such as a microprocessor, and a number of other units interconnected via a system bus. The workstation includes a Random Access Memory (RAM), Read Only Memory (ROM), an I/O adapter for connecting peripheral devices such as disk storage units to the bus, a user interface adapter for connecting a keyboard, a mouse, a speaker, and/or other user interface devices such as a touch screen (not shown) to the bus, communication adapter for connecting the workstation to a communication network (e.g., a data processing network) and a display adapter for connecting the bus to a display device. The workstation typically has resident thereon an operating system such as the Microsoft Windows Operating System (OS), the IBM OS/2 operating system, the MAC OS, or UNIX operating system. Those skilled in the art appreciates that the present invention may also be implemented on platforms and operating systems other than those mentioned.

The workstation interfaces with the networked environment (Internet) on a communications access device such as a telephone or cable modem on a personal computer, DSL, ISDN, satellite or other appropriate communications line. Secure interface is provided from the workstation via the communications device that is in communication with a gateway computer system that utilizes authentication and/or security protocols.

Some examples of security protocols to provide such a secure transmission channel is a general-purpose secure communication protocol such as Netscape, Inc.'s Secure Sockets Layer (hereinafter “SSL”). The SSL Protocol provides a means for secure transmission between two computers. SSL has the advantage that it does not require special-purpose software to be installed on the customer's computer because it is already incorporated into widely available software that many people utilize as their standard Internet access medium, and does not require that the customer interact with any third-party certification authority. Instead, the customer, e.g., the Netscape Navigator World Wide Web browsing tool, may incorporate the support for SSL into software already in use. Other examples of general-purpose secure communication protocols include Private Communications Technology (“PCT”) from Microsoft, Inc., Secure Hyper-Text Transport Protocol (“SHTTP”) from Theresa Systems, Pretty Good Privacy (“PGP”) and Ipv6. One of ordinary skill in the art readily comprehends that any of the general-purpose secure communication protocols can be substituted for the SSL transmission protocol without undue experimentation.

It is the gateway computer system and associated software that a computer user may use to generate, store and transmit an accurate user profile. The gateway computer system is in secure communication with a second computer via a network, preferably the Internet. The gateway computer system is authorized by a first computer user and has the responsibility of verifying the accurate profile of the first computer user to other users of the computer network via the gateway computer system. Also, the gateway computer system has the responsibility of verifying the accurate profile of other computer users to the first computer user.

Another attempt to provide a related function is a secure payment technology such as Secure Electronic Transaction (hereinafter “SET”), jointly developed by the Visa and MasterCard card associations. Other such secure payment technologies include Secure Transaction Technology (“STT”), Secure Electronic Payments Protocol (“SEPP”), Internet Keyed Payments (“IKP”), Net Trust, and Cybercash Credit Payment Protocol. Such secure payment technologies require the customer to operate software that is compliant with the secure payment technology, interacting with third-party certification authorities, thereby allowing the customer to transmit encoded information to a merchant, some of which may be decoded by the merchant, and some which can be decoded only by a payment gateway specified by the customer.

The present invention is directed to a software system for operating on network servers, with supporting applications operating on an individual user's personal computer system, inclusive of wire-line and wireless tele-computing devices. This invention is directed to a system for allowing an individual or entity to author, generate, validate, purchase and control authenticated personal and/or commercial profiles on a computer network, including the Internet. Specifically, this invention facilitates the development of these profiles via a website that creates verified profiles. The Level I profile tells the person's gender, age and screen name. The Level II profile allows the user the option of giving any particular website their real name and personal information or the option of publishing a photo. Level III profiles which allow the user the option of giving any particular website their financial information. Also offered are group profiles.

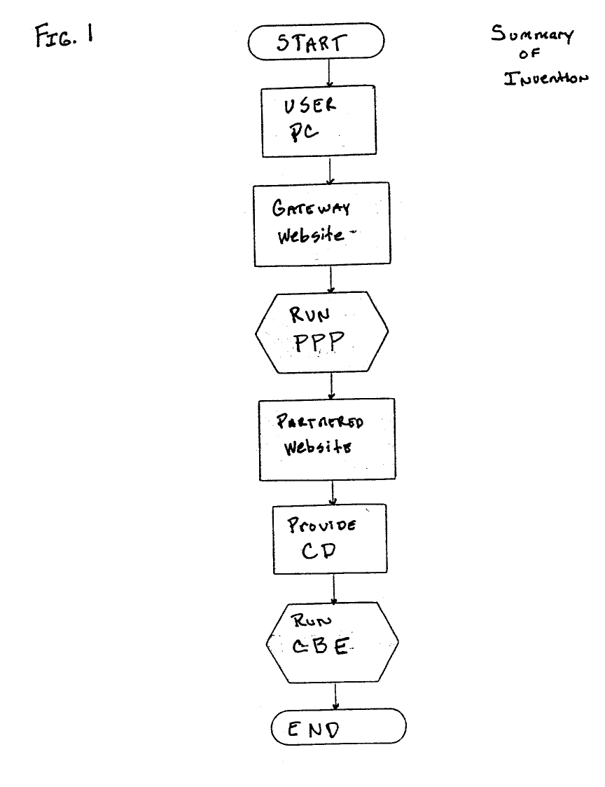

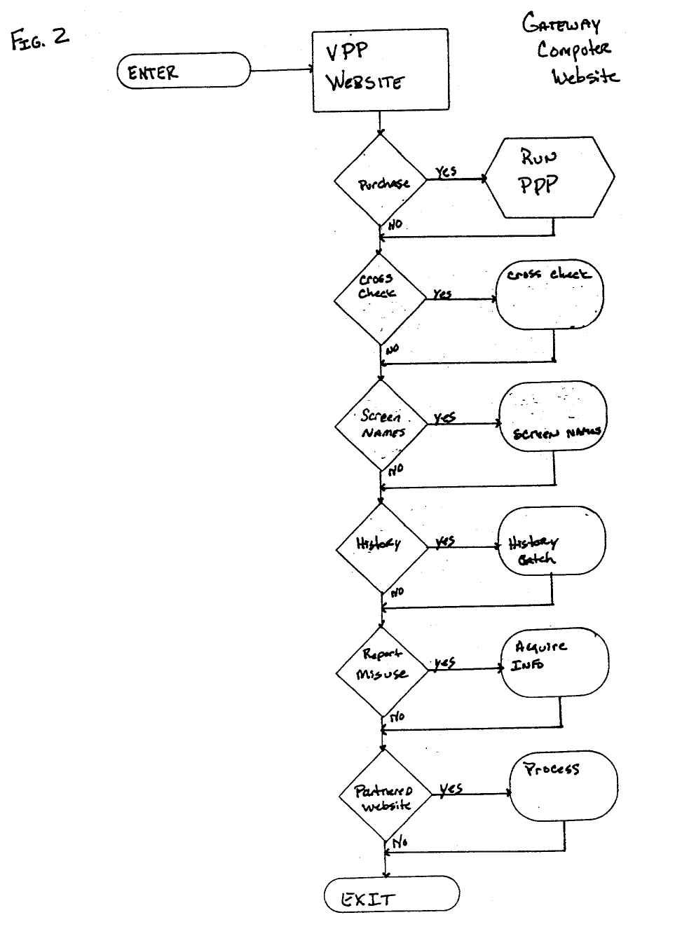

FIG. 1 shows the summary of the invention for the overall process for authoring, authenticating, verifying and exchanging users VPP according to the invention.

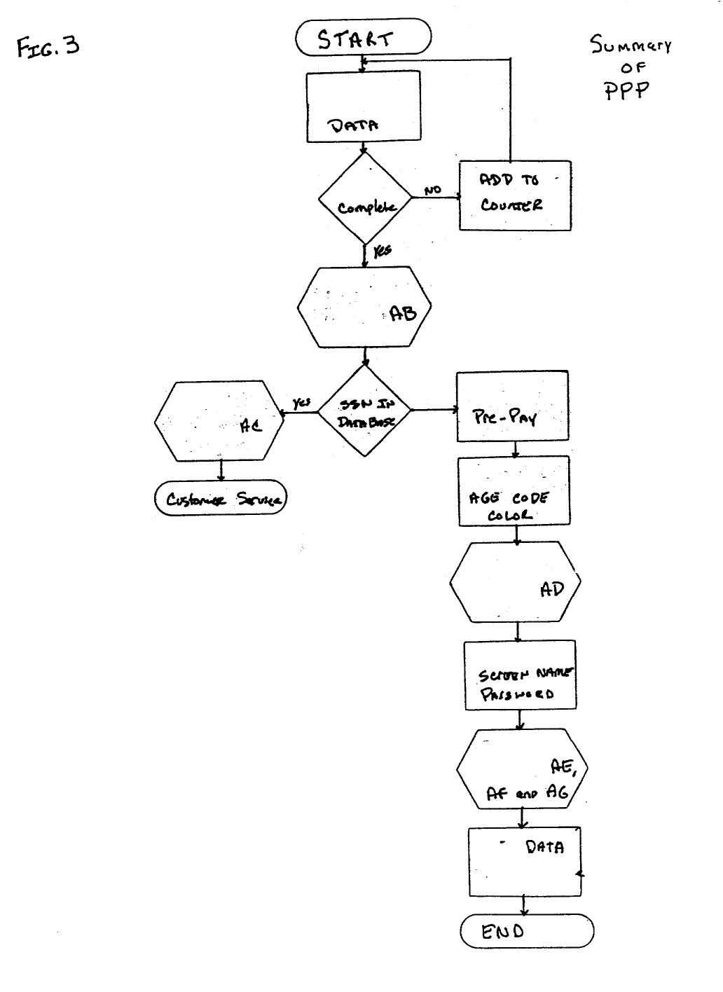

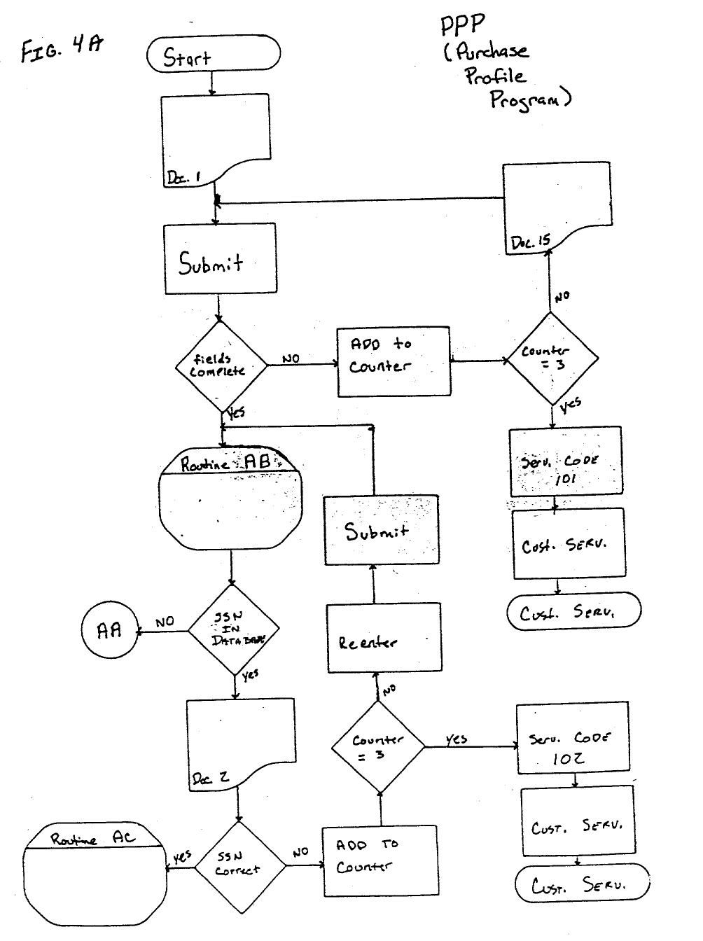

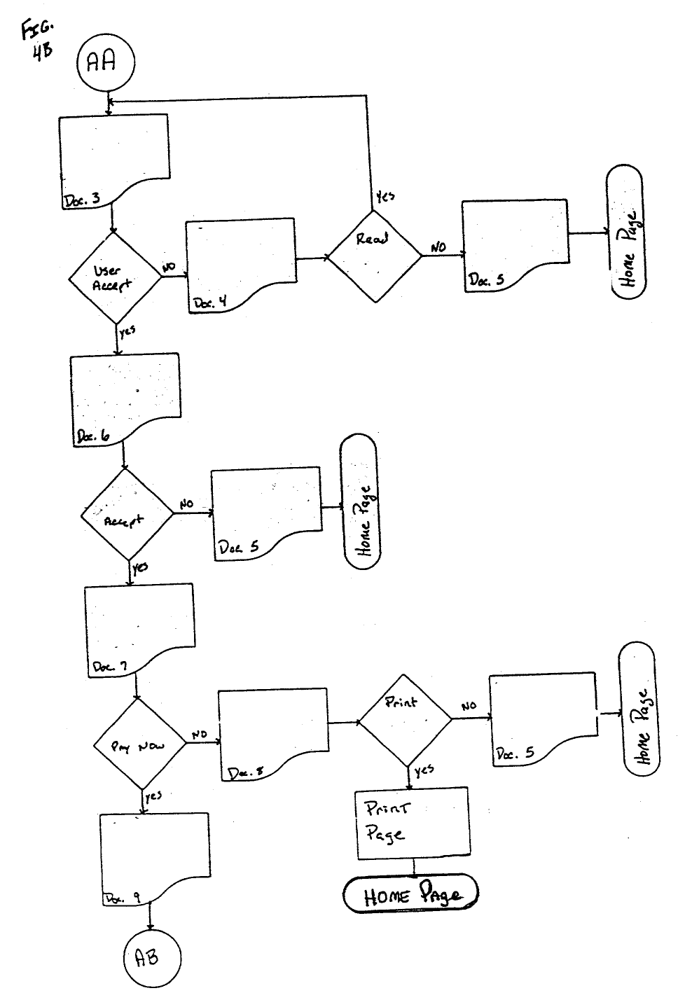

The preferred embodiment of the invention primarily operates on a network server, with supporting applications operating on the individual's personal computer system. To a user, the preferred embodiment appears as a website, so it may be accessed simply by knowing its website address. FIG. 2 shows an example of the Internet web page that offers to generate profiles for users via the Internet. Web page may be, for example, an HTML page, and may include functionality provided by Java applets, as is well known in the art. As mentioned herein above, the website preferably has a comprehensive security safeguard: firewalls, proxy servers, SSL enabled Web servers and clients, digital certificates, hardware tokens, security policies and procedures, and encryption.

Referring to FIG. 2: In the example of FIG. 2, web page contains a list of informational and interactive elements (questions), purchasing elements, customer service elements. The website works in conjunction with users and websites using several software programs installed on the gateway computer system, including a Purchase Profile Program (PPP) and associated subroutines, a Profile Interactive Program (PIP) and associated subroutines, and software to be installed on a user's PC such as a PC Interactive Program (PCIP) and software installed on a CD or disk (as needed) Interactive Program (CIP), as well as software installed on partnered websites such as a Website Interactive Program (WIP) and associated subroutines.

FIG. 2 shows the preferred elements on a gateway website homepage that may be accessed by a computer user. A series of interactive questions with related answers (links) may be available.

An example of a question in the preferred embodiment of the website includes, for example: those related to purchase of a profile. “Would You Like to Purchase a Personal Profile?” would route the potential purchaser to the PPP subroutine described herein below. “Would You Like to Check Available Screen Names?” would allow a visitor to the website to view whether a preferred screen name for a profile was in use and provide alternate suggestion for similar screen names.

Other questions include those related to ensuring the security of a profile. “Would You Like to Check Your SSN?” would allow a visitor to the website to determine whether his (or a family member's) SSN was being used or misused. “Would You Like to Check the History of Your Profile?” would allow a user to view the history of their profile, which may for example show unauthorized accesses to the profile. “Would You Like to Report Misuse of a Profile?” would allow a user to report to customer service the misuse of his or her own or another's identity or profile. “Would You Like to Be a Sponsor or an Interactive Website?” would introduce interested sponsors, partners, cross-links and the like to the gateway website and administrative personnel.

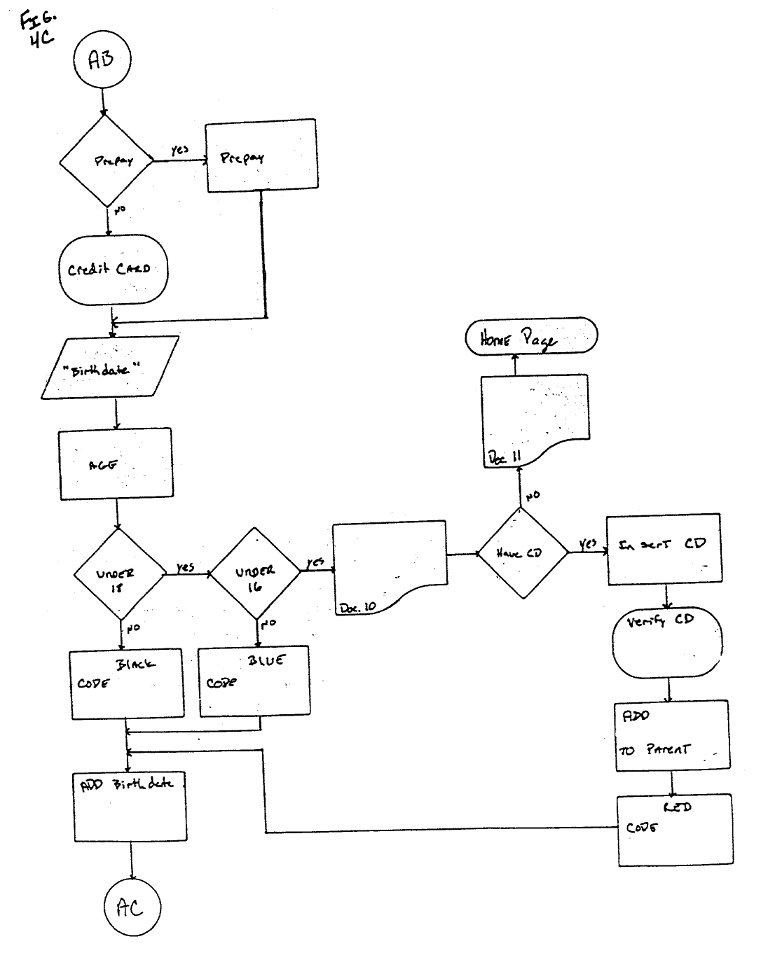

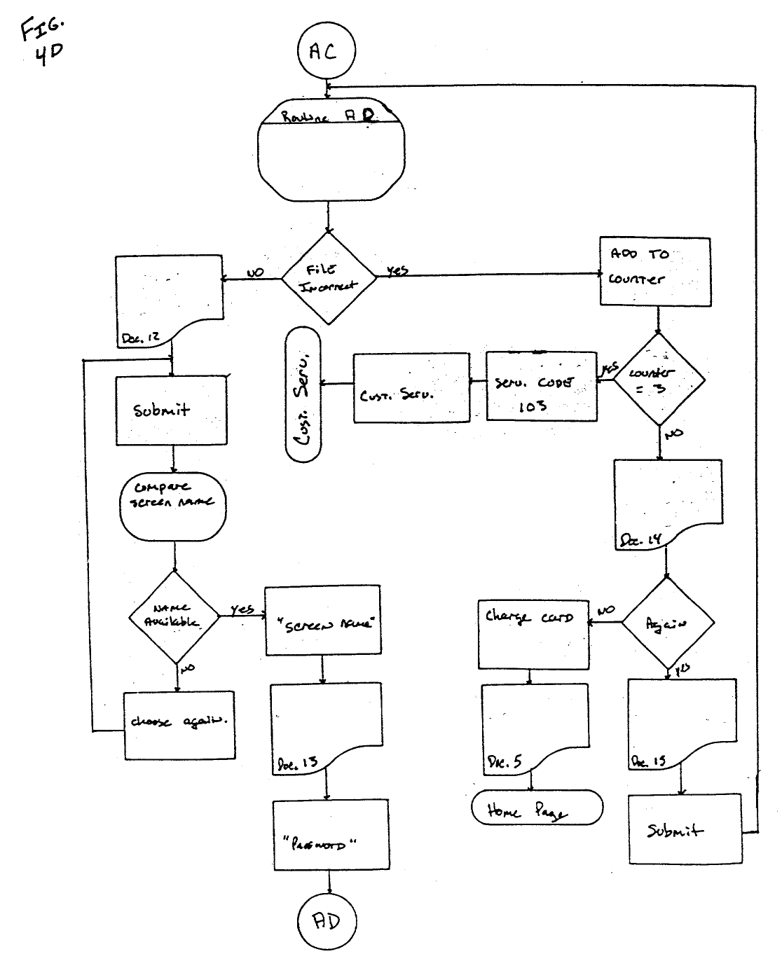

After a computer user has reviewed the information available on the Home page of the gateway website, the user may then desire to purchase a profile. The “Would you Like to Purchase a Personal Profile?” link would route the potential purchaser to the Purchase Profile Program “PPP” routine. FIGS. 4A-10 shows a flowchart/decision model for the purchase of a profile by a user. The PPP is also linked through various decision blocks to other routines that crosscheck and ensure the security of the profile.

Referring to FIG. 4A: At the start of the PPP the user is provided with an ID Profile Application, (Document 1) such as “Profile Application. Please complete all fields below: Please enter your Social Security number ___ __ ____ Please enter your name (as it appears on your social security card) Male ______ Female ______ Please enter your mailing address (required to ship your profile) Your Birth date Month ______ Day ______ Year______ Submit”. The user fills in the user's Social Security Number (SSN), name (as it appears on their SSN card), gender, mailing address and birth date information in customer information entry area, and clicks on the submit button.

The PPP then verifies that all fields are complete. If all the fields in the ID Profile Application are not complete a counter initially at 0 adds 1 to the counter. If the counter is at a number less than 3, the user is displayed and error message as in “Please examine information and correct any mistakes” (Document 15), asking the user to complete the missing fields in the ID Profile Application. If the counter has reached 3, a customer service code of 101 is attached to the user's application signifying to customer service that the user is not completing all of the fields on the application. The user is then connected/linked to a page or representative in the customer service department. The counter program prevents people from guessing and misappropriating profiles under false identities, or helps people having a language barrier or other need that makes completion of the ID Profile Application difficult.

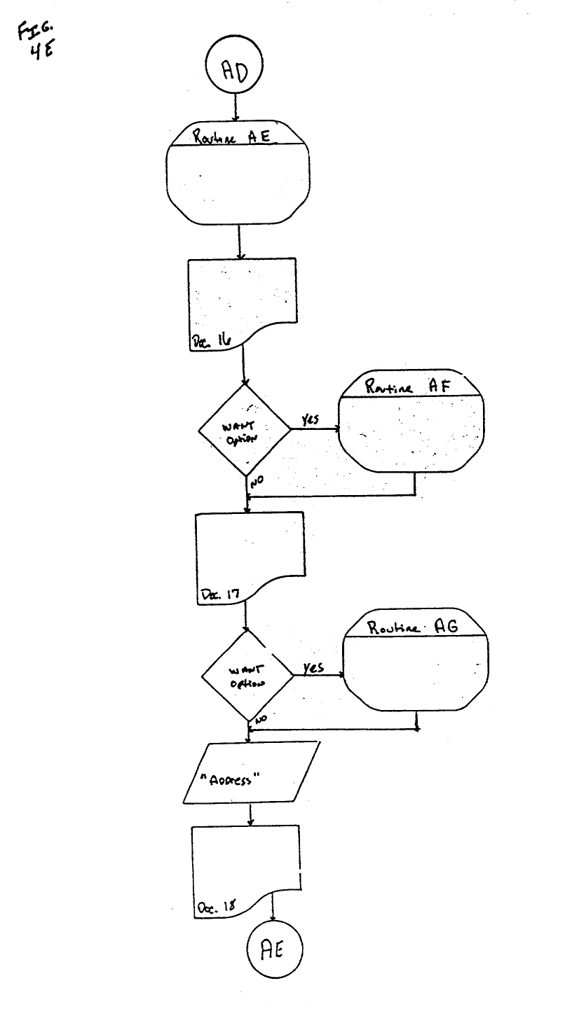

Referring to FIG. 5: If the user successfully completes the fields in ID Profile Application, a subroutine (AB) is performed on the application to crosscheck the SSN in the ID Profile Application to a database of profiles stored on the website network. The routine reads the SSN field of the ID Profile Application and compares it to the SSN's in the profile database. If the SSN matches that of a profile in the database, the output field is named to “match“. If the SSN does not match that of a profile in the database, the output field is named to “SSN”. The output field of routine AB is returned to the PPP corresponding to whether or not the SSN submitted is being used under profile currently in the database.

If the SSN is being used, the user is shown an error message such as “SSN Being Used. Warning. The Social Security number you just entered is currently assigned to another profile. Please review the number and make sure you entered it correctly. Is this your correct Social Security Number?” (Document 2). The user is prompted to answer yes or no in response to this query. If the user answers no, a counter initially at 0 adds 1 to the counter. If the counter is less than 3, the user is prompted to re-enter their correct SSN and the crosscheck subroutine AB is performed anew. If the counter has reached 3 a customer service code of 102 is attached to the application signifying to customer service that the user has submitted 3 SSN's to a profile application. The user is then connected/linked to a page or representative in the customer service department. The counter program prevents people from guessing and misappropriating profiles under false identities, or helps people having a language barrier or other need that makes completion of the ID Profile Application difficult.

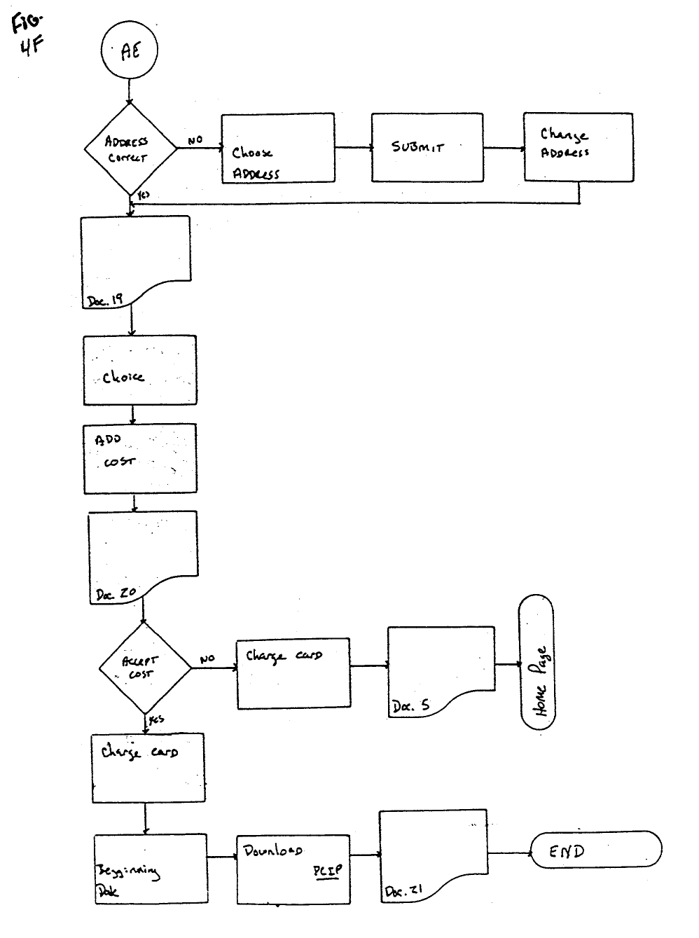

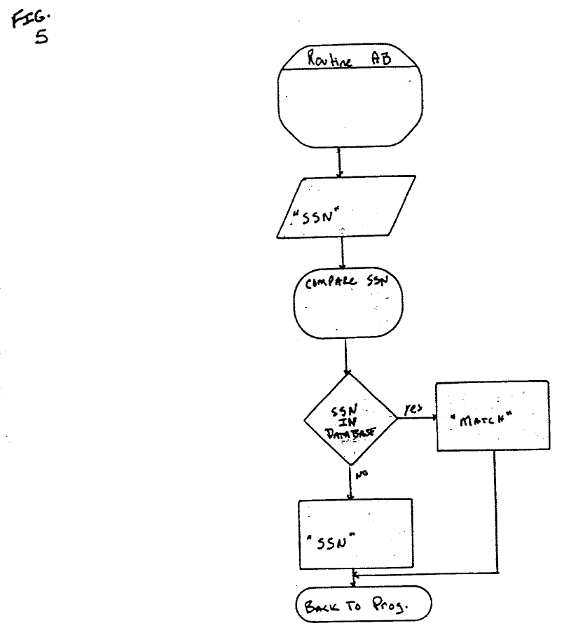

If the SSN is being used, and the user responds yes to the error message “SSN Being Used. Warning . . . Is this your correct Social Security Number?” (Document 2), the user is routed to the SSN Misuse subroutine (AC). The SSN Misuse subroutine AC as illustrated in FIG. 6, first compares the information in the new ID Profile Application to information currently in the database. The subroutine determines whether the fields of the new and current ID Profile Applications match each other. If the new ID Profile Application and database profile match the profile is put on “hold” status and a customer service code of 105 corresponding signifying the profile has been put on hold because the new user claims the SSN is their own although the user is not a current profile holder and the ID Profile Application information is correct. The user is then put in contact with customer service. If the new ID Profile Application and database profile do not match, the user is shown a “SSN Warning Message, Warning! You have entered Invalid Information. Would you like to contact our customer service department?” (Document 22), and is put in contact with customer service. If the user does not wish to contact customer service they exit the PPP program and return to the gateway homepage. If the user wishes to contact customer service, a service code of 104 is attached to the application signifying that the user claimed the SSN was theirs, but that the verified information in the database does not match the information entered by the user in the ID Profile Application. The user is then connected/linked to a page or representative in the customer service department.

Referring back to FIGS. 4A and 4B, if the outcome of the cross-checking subroutine AB shows that the SSN does not correspond to that of a SSN being used in the profile database, the PPP program continues on to verify whether the user consents to allow the website to use their ID Profile Application information. Specifically, the user is shown a contract for release of information (Document 3), stating that the website intends to verify the ID Profile Application information submitted for verification against the information located in the Social Security Administration (SSA) database, or related databases. If the user does not accept the release contract a Non-Acceptance Message as in FIG. 4B is displayed stating, “Please understand that without the acceptance contract we will not be able to process your application. Your personal information will only be used to verify your identity, and will not be shared with a third party” (Document 4). The user is queried as to whether they wish to read the release contract again. If the user submits “yes” the release contract is again displayed. If the user wishes not to view the contract, the user is shown a thank you message, such as “Thank you for considering Verified Personal Profiles. We sincerely hope we can assist you in the future with your profile needs.” (Document 5), and exits the PPP returning to the homepage.

If the user accepts the release contract a verification charge document is displayed stating ” Verification Charge. For security reasons, there is a charge (small amount of dollar amount shown) for processing your Social Security Number, regardless if you qualify or not. Rest assured that if the information you are supplying right now is indeed accurate and belongs to you, this charge would not be an issue. Do you accept this condition? Yes______ No_____” (Document 6). If the user does not accept the charge verification, the user is shown a thank you message, such as ” Thank you for considering Verified Personal Profiles. We sincerely hope we can assist you in the future with your profile needs.” (Document 5), and exits the PPP returning to the homepage.

If the user accepts the charge verification, the user is shown a Pay Now Message stating ” Because of the condition above, we must be able to charge you now for this service. That will require a charge card or check number. Can you pay now? If not, we offer a prepay option. Answer yes if you have completed a prepay application. Answer no if are unable to pay. Yes______ No______.” (Document 7). If the user answers no, a prepay option document is displayed stating “Prepay Option. If you are unable to pay now, you may elect to use our prepay option. The home page offers a link titled (Profile Cost). This page explains the profile options and total cost you can expect to pay. Once you decide your total expected cost, send a money order or check to this address: Attention: Prepay Option, (Website address). Please include your e-mail (or a way to contact you). After processing your prepay, we will immediately contact you. You may then answer the previous question: ‘Can you pay now?’—Yes. Thank you for choosing Verified Personal Profiles. Would you like to print this page? Yes______ No______“ (Document 8). If the user responds in the negative, the user is shown a thank you message, such as “Thank you for considering Verified Personal Profiles. We sincerely hope we can assist you in the future with your profile needs.” (Document 5), and exits the PPP returning to the homepage. If the user chooses to print the Prepay Option page, they then exit the PPP and return to the homepage. Upon submission of a prepayment to the website address, the user will be assigned a confirmation number for later use.

If however, the user responds, “Yes” to the Pay Now Document, a Charge Card Verification document is displayed to the user stating, “Please fill out payment application: Charge card # ______ . Expiration date _______ . Debit card # ______ . Expiration date _______.Prepay confirmation # _______” (Document 9). Once a field has been filled in the charge verification, the PPP continues on to process the charge. Firstly, the PPP checks whether the user filled in the prepay option field. If so, the prepay confirmation number is compared to that in the database file for the corresponding ID Profile Application and does not process as it would for a credit or debit card. If the user did not fill in the prepay option field, then the users credit card or debit card are processed using conventional merchant accounting methods.

Referring to FIG. 4C: After the payment has been processed, the users age is computed. More specifically, the user's age is computed by subtracting the user's birth date (as entered in their ID Profile Application) from the current date. Depending on the user's computed age, their file is coded differently. If the user is 18 years of age and over, their file is coded “black”. However, if the user is 16 or 17 years of age, their file is coded “blue”. If the user is under the age of 16, a parent authorization message is displayed such as “Parent Authorization Needed. We welcome all young users to the world of profiles. Thank you for your decision to let us protect you. Our future is in your hands. To ensure extra protection for you, we must require a parent (or authorized adult) profile to connect with you. Do you have their profile C.D.? Yes______ No______” (Document 10).

If the user does not have parental authorization in the form of their parent's profile access CD, the user is shown a thank you message such as “Please try again when you have your parent or guardian's profile. We value your protection and will help you in any way possible to get a profile.” (Document 11), and exits to the home page. If the user does have parental authorization in the form of their parent's profile access CD, the user inserts the CD and the access code thereon is verified as valid. The underage user is then added as a connection via the parents existing profile, then the underage users profile is coded red. A calendar counter verifies the age of the user so that each time the user accesses the site, it may determine when the user has attained an age corresponding to a different color code, also rolls over verified age.

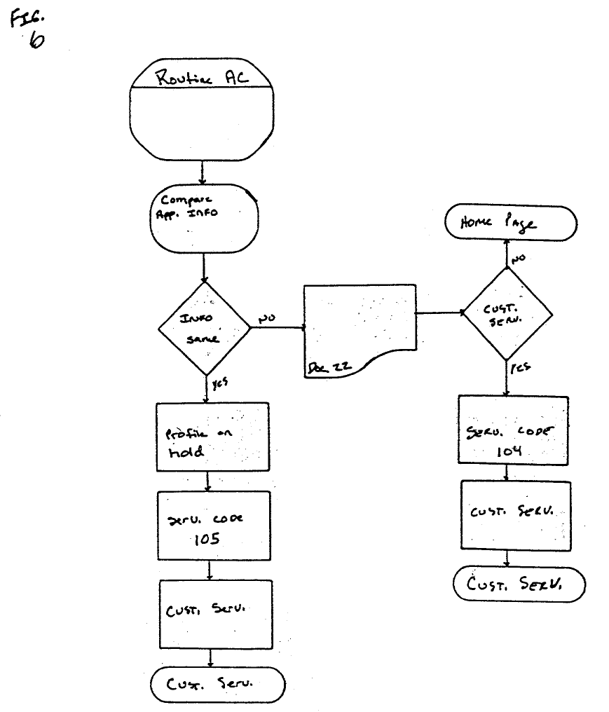

Referring now to FIGS. 4D and 7: Once the age of the user has been verified, a software routine is applied to the users information to determine the validity of their submitted information with the Social Security Administration (SSA), or related databases. Specifically, the profile verification subroutine (AD) reads the submitted SSN, name, gender and birth date fields. The subroutine AD then compares all these fields to those contained in a current copy of the SSA database or related databases. If any of the fields do not match, the output file of the subroutine is named “Incorrect” and returns to the PPP. If all of the fields match, the output file of the subroutine AD is named “Profile”, and is copied to the website Profile database and then returned to the PPP.

If the output file of the verification subroutine AD is “Incorrect” a counter program (Initially set at 0) adds 1 to the counter. If the counter is at a number less than 3, the PPP displays a warning such as “Wrong SSN Warning: Warning! You have entered invalid information. The information must match your current information at the Social Security Administration. If you need to contact them, their number is _______ (It is a federal crime to use someone else's SSN.) Do you want to continue? Yes_______ No_______” (Document 14). The user is then prompted as to whether they wish to continue attempting to enter a profile. If the user does not wish to continue, their payment (for SSA access) is processed, and a thank you message such as “Thank you for considering Verified Personal Profiles. We sincerely hope we can assist you in the future with your profile needs.” (Document 5), and exits the PPP returning to the homepage.

If the user wishes to continue attempting to enter a profile, the completed ID Profile Application is again displayed to the user, for example “Completed ID Profile Application: Please examine information and correct any mistakes. Submit” (Document 15). The user may then submit corrections to the ID Profile Application up to a maximum of 3 times as dictated by the counter program. If the counter has reached 3 a customer service code of 103 is attached to the application signifying to customer service that the user SSN information is inconsistent with the SSA database. The user is then connected/linked to a page or representative in the customer service department. The counter program prevents people from guessing and misappropriating profiles under false identities.

If however the output file of the SSN verification subroutine AD is a “Profile” the user is prompted to choose a screen name. The screen name is a unique name associated with the users profile. The prompt for example my be: “Choose Screen Name: All screen names are unique. Please choose carefully. You will only be allowed to change your screen name 3 times in a 12-month period. If you change your screen name, a caption will appear with your new name. For example: New Name_______ Formally known as “________”. Type in choice_______ “Submit_______” (Document 12). Upon submission of a screen name, the PPP will compare the chosen screen name to those screen names already existing in the website database. If the name is already taken, the user is prompted to choose another. The PPP will also provide suggestions as for example alphanumeric variants of the originally chosen screen name. New screen names will be submitted until an unused screen name is selected.

Once the user has selected a novel screen name, the user in prompted to choose a password. A sample password selection message is: “Choose Password: Please choose a password. Try not to make it obvious. Remember to keep your password in a secure location. Along with your screen name, this will be your key to access your profile. Fill out the form below in case you forget your password. (Create a security question for forgotten passwords) Enter Password. Submit” (Document 13). A user password interface may also require the user to reenter password to ensure accuracy.

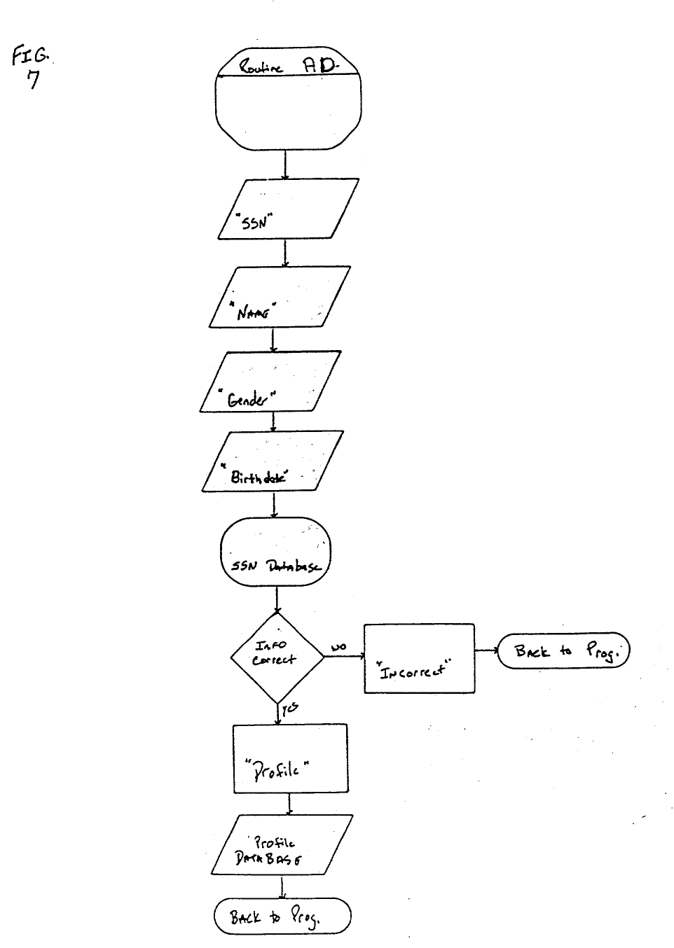

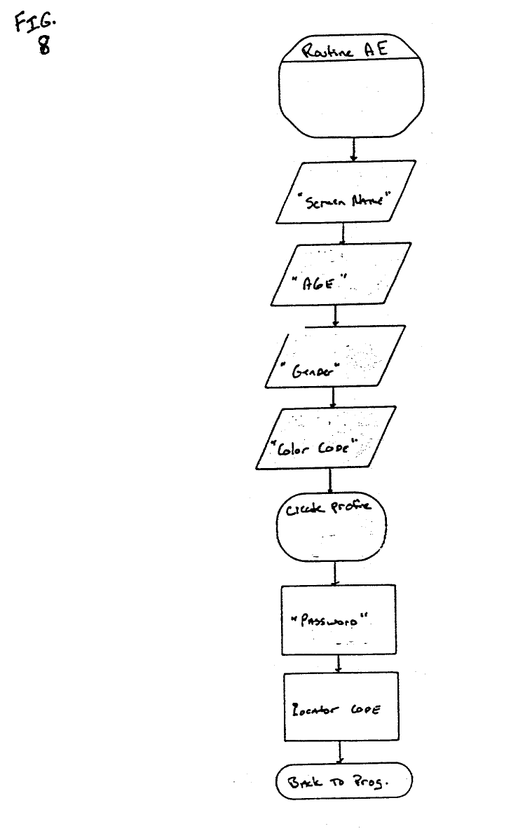

Referring now to FIGS. 4E and 8: After the user has selected a screen name and password, the PPP uses an ID Profile creation subroutine AE, which creates the user's profile, which is stored on the gateway computer system. To create the user's profile, the subroutine AE reads the users; screen name, age, gender and color-code and writes the information to a database. The password associated with the profile is assigned to a location resident on the gateway computer system. The location of the password has a locator code assigned therewith, which locator code is written to the profile CD or disk (as needed). The user may later use the CD on a PC and using the password locator code to access the profile on the website using the PCIP and CIP described below.

Referring now to FIGS. 4E and 8: After having generated a personal profile (Level I), the user may also generate a Business Level II Profile. The Business Level II Profile Options are those options associated with sharing personal information with partnered websites with the users permission. An example statement related in initiating a business profile includes: “Our business profile gives you the option of letting us manage your personal information. We have contractual agreements with all websites who use profiles. This contract states that the website must inform you of their reasons for requiring your personal information. If you accept their reasons, they can use your information only for that purpose. Do you wish to purchase the business profile? (At a price of (insert price). Yes______ No_______” (Document 16).

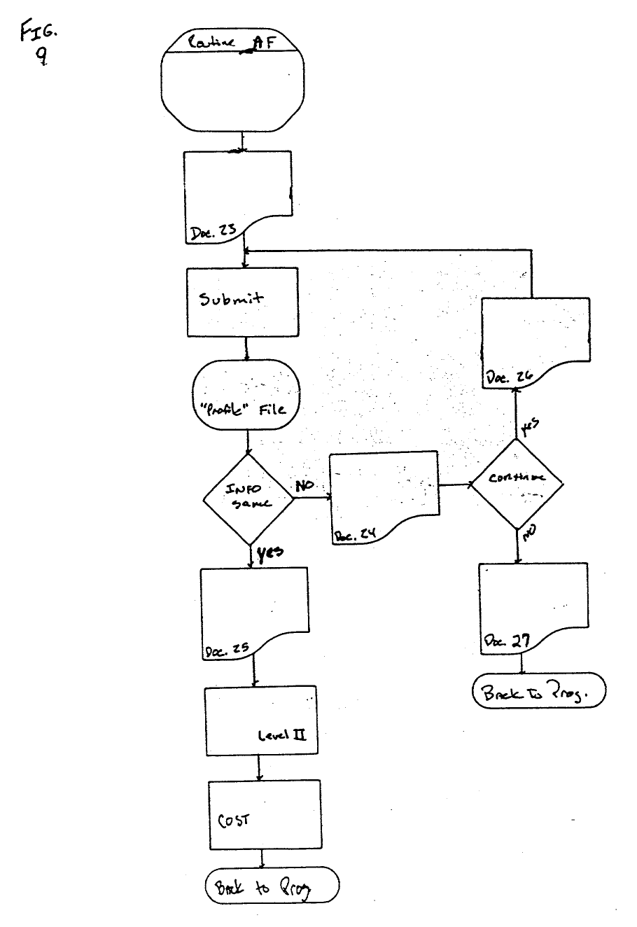

Referring now to FIGS. 4E and 9: If the user chooses to create a business Level II profile, a business Level II profile subroutine (AF) is processed. The business Level II profile subroutine first displays to the user a business Level II profile application containing for example the following statement: “When you use your Business Level II Profile, the information you provide in this section will be made available to you. You will then decide which information you give a particular website. Your SSN, name, gender and birth date information must match the information in your I.D. Level I Profile. Those fields are marked with an asterisk. Please submit as much information as you feel you will need. (Blank Application) Submit” (Document 23). The information in the business Level II profile application will be available for the user to share with partnered websites and the amount of detail in the business Level II profile information is up to the user.

When the business Level II profile application is submitted, the subroutine AF compares the mandatory fields (SSN, name, gender and birth date) to ensure that they match the information in the user's Level I profile. If the information in the SSN, name, gender and birth date fields do not match, the user is prompted with a message such as the following: “Need Same SSN Information. The identification information you provide in this section must match the information on your Social Security Card. In order to use different information, you must change your current information, with the Social Security Administration. You can contact them online at www.ssa.gov. In order to complete your Business Level II Profile today, you must use your official information. You can edit this information after you file with the SSA. Continue______ Exit_______”. (Document 24).

If the user at this point chooses not to continue, i.e., exit, the user is shown a message such as: “Thank you for considering the Business Level II Profile Level” (Document 27), and exits back to the PPP. If the user does choose to continue, the user is shown their submitted business Level II profile and asked to correct the non-matching fields with a message such as “Please review and revise your information. Submit” (Document 26). When the user's submitted SSN, name, gender and birth date fields match those of the Level I Profile ID Application, the user is then prompted to choose a personal identification number (PIN) with a message such as “Choose Business Level II profile PIN. You now need to choose a Business Level IT PIN number to access your information Enter Number _______ Submit” (Document 25). Optionally guidance as to how many numbers should be in the PIN (e.g., a minimum of 4 numbers) may be included. This PIN number is then written to the user's profile at the gateway computer system to allow later access to that file. After a PIN has been selected and accepted, the subroutine AF then adds the business profile fee to the total cost of the user's profile and returns to the PPP.

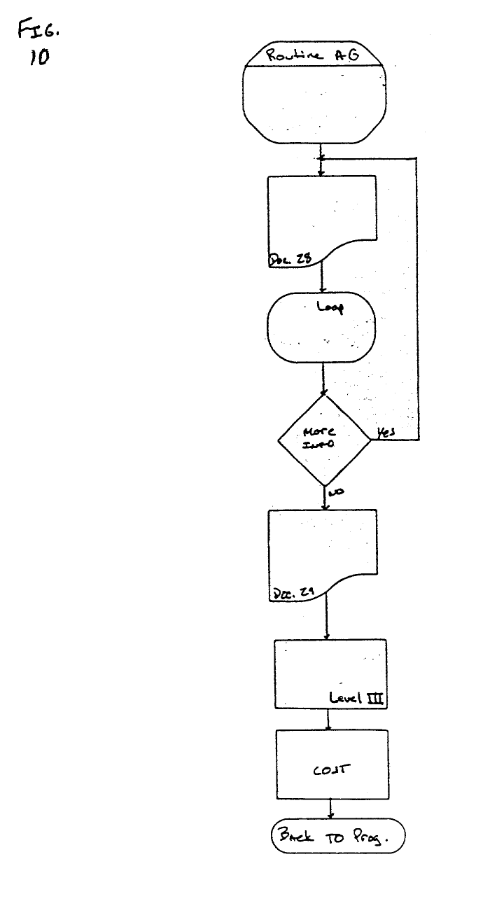

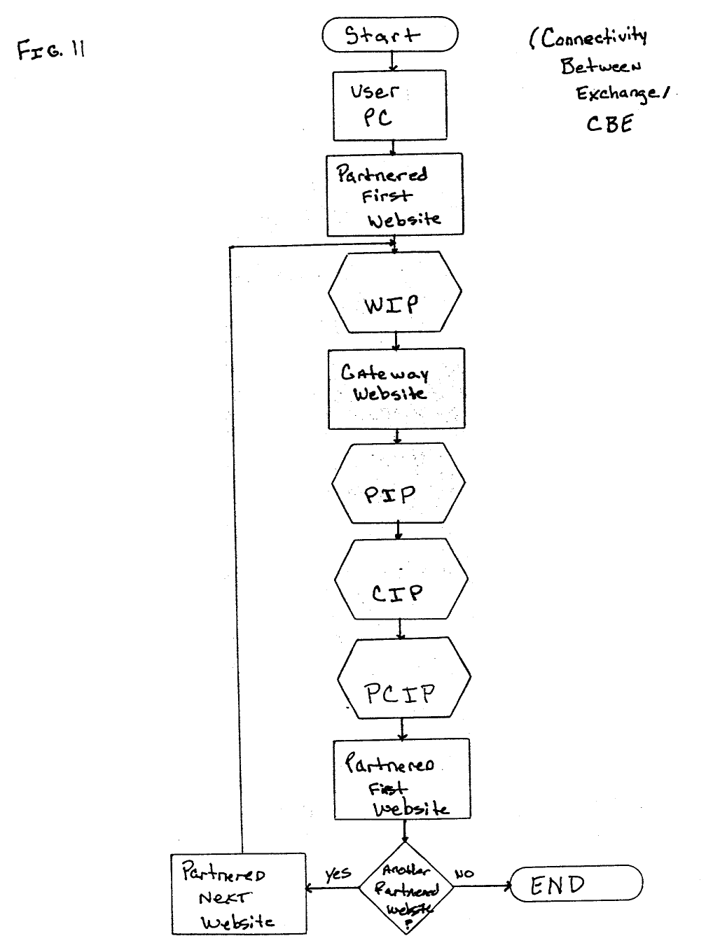

Referring to FIGS. 4E and 10: After having generated a personal profile, the user may also generate a Business Level III Profile. The Business Level III Profile Options are those options associated with sharing commercial information with partnered websites with the users permission. An example statement related to initiating a Business Level III Profile includes: “Business Level III Profile Option. Our Business Level III Profile allows you to keep all of your financial information in a secure, convenient location. It is a Data Management source that enables you to access your financial records easily when doing business online. For a cost of (enter price). Would you like this option? Yes_______ No_______ ” (Document 17).

If the user chooses to create a Business Level III Profile, a Business Level III Profile creation subroutine (AG) is processed. The Business Level III Profile subroutine first displays to the user a Business Level III Profile application containing for example the following statement: “Business Level III Profile. Your Business Level III Profile will contain all your financial information. Please include all information you feel is necessary to accomplish your needs.

Bank Account Information______

Credit Card Information______

Submit” (Document 28). After having submitted the information, the user is again prompted to enter financial information for the Business Level III Profile until the user has submitted all they want. A message states for example “Would you like to enter more information? Yes _____ No ______” If the user desires to enter more information they are returned to the Business Level III Profile financial information entry page. If the user does not desire to enter additional information, the user is then prompted to enter a PIN for accessing their Business Level III Profile. The message displayed may state, “Choose a Business Level III Profile PIN. You now need to choose a PIN Business Level III Profile number to access your information.

Enter Number _______ Submit” (Document 29).

Optionally guidance as to how many numbers should be in the PIN (e.g., a minimum of 4 numbers) may be included. This PIN number is then written to the user's profile at the gateway computer system to allow later access to that file. After a PIN has been selected and accepted, the subroutine AG then adds the Business Level III Profile fee to the total cost of the user's profile and returns to the PPP.

Referring back to FIGS. 4E and 4F: Once all the profile information has been entered, the PPP completes the process of assigning the user a profile by verifying shipping and charge information. The PPP reads the address field submitted in the profile and displays a shipping message such as “Via Mail Using Address. One of our most important security features is requiring an address to send you a profile. The address you give us should be a place you feel secure about receiving mail. Is the address you provided in this application where you want your profile sent? Yes_______ No_______“ (Document 18).

If the user prefers a different address, the user is prompted to enter a new address, which updates the address field in the users profile. Otherwise the address currently in the user's profile is used as the shipping address. The user is then shown their shipping option with a message such as “Shipping Options. You have several options in your decision to receive your profile. Listed below are those choices and the cost associated with them. Please choose one. Overnight ________ Priority______ U.S. Postal Service_______. Submit” (Document 19). After choosing a shipping option, the cost of shipping is calculated and then added to the total cost of the user's profile (which includes the SSA database verification fee, the personal profile fee, the fees for business II and business III profiles if selected, and the shipping charges). The user is then shown the total cost in a message such as “Total Cost. The total cost of your profile is ______. Do you accept? Yes_______ No_______” (Document 20).

If the user does not accept the charges, then the user is charged only for the SSN verification. The user is then shown a message such as “Thank you for considering Verified Personal Profiles. We sincerely hope we can assist you in the future with your profile needs.” (Document 5), and exits the PPP returning to the homepage. If the user accepts the charges then the user is charged for the SSA database verification fee, the personal profile fee, the fees for business II and business III profiles if selected, and the shipping charges. The user is told when an additional fee for maintaining their profile will be due, e.g., an annual subscription.

The user is then allowed to download from the website or linked FTP site an interactive program, namely the Personal Computer Interactive Program (PCIP) described below. Having completed the profile, the user is shown an exit thank you message such as “Congratulations! You have successfully completed your Verified Personal Profile application and have been approved. You now own the tool to a responsible Internet experience. Your Verified Personal Profile will be immediately sent to you. Thank you for your participation in this global attempt to bring order to cyberspace. Exit” (Document 21). The user then exits the PPP and returns to the homepage.

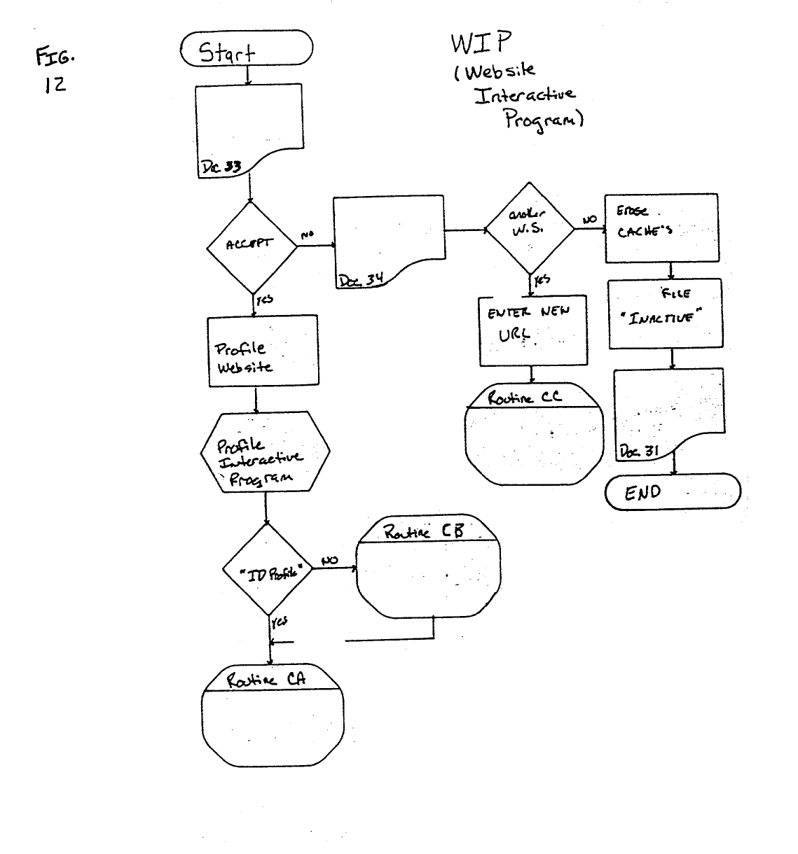

Referring now to FIG. 11: Following the successful purchase of a profile, the user is then sent a “burn-safe”, i.e., non-rewritable CD or disk (as needed) containing the CIP and the encrypted locator code for accessing their profile on the gateway website. The CD or disk (as needed) in conjunction with software resident PCIP located on the user's PC and the PIP located on the gateway computer and the WIP located at the interactive website allows the user to access and share their profile upon entry of a valid screen name and password. These redundant security measures allow the user to share a verified profile with others without fear of interception, and provide other users and websites with the security that the information in the profile is authentic.

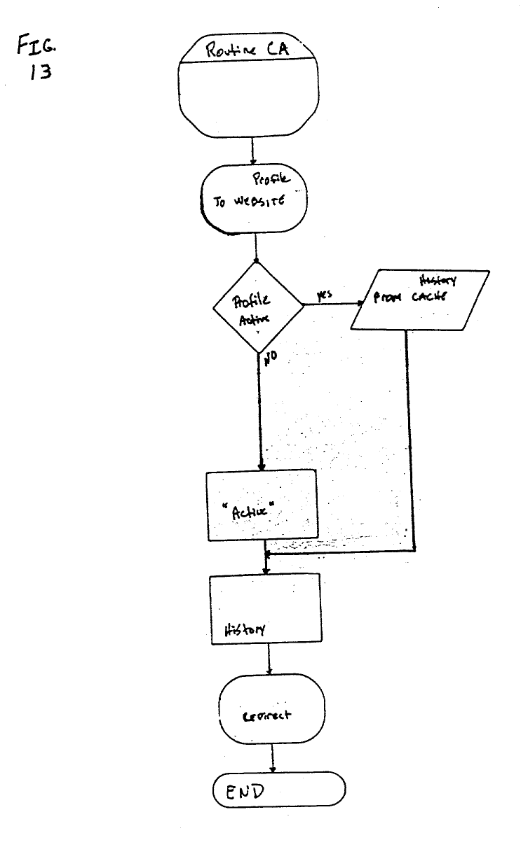

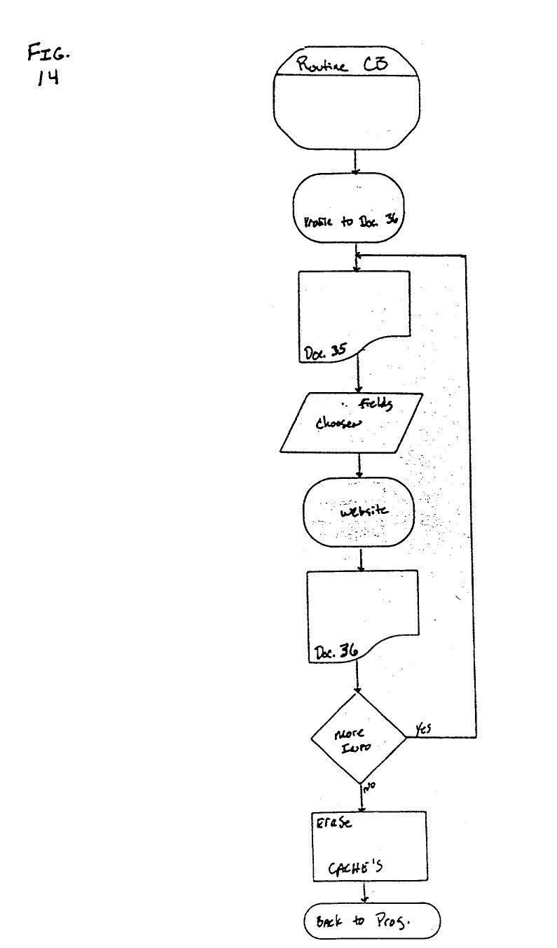

Referring now to FIG. 12: Partnered websites that want to use Profiles for their users will be sold or licensed software, the Website Interactive Program (WIP) links them to the gateway computer. A partnered website will receive from the profile gateway website the profiles of each user on a case-by-case basis. The user grants permission to a website by entering the user's screen name and password into the WIP which connects the partnered website to the profile database of authentic profiles.

More specifically, when a user visits a partnered website that has the WIP software installed thereon, the user may choose to share their profile information with that website. The website first discloses to the user the limited purpose for which it intends to access the user's profile information (Document 33), and at which level of profile information is used. For example, the partnered website may use Level I ID profile information for exchange with other members of a chat room. The web site may alternately require Level III Profile information for verifying financial data in the context of a commercial transaction.

If the user accepts the purpose for the profile use, then the user is linked to the gateway website and the PIP is launched. If after exiting the PIP in the WIP, the user's profile corresponds to an ID Profile, a “Hand Holding” subroutine (CA) is launched as in FIG. 12.

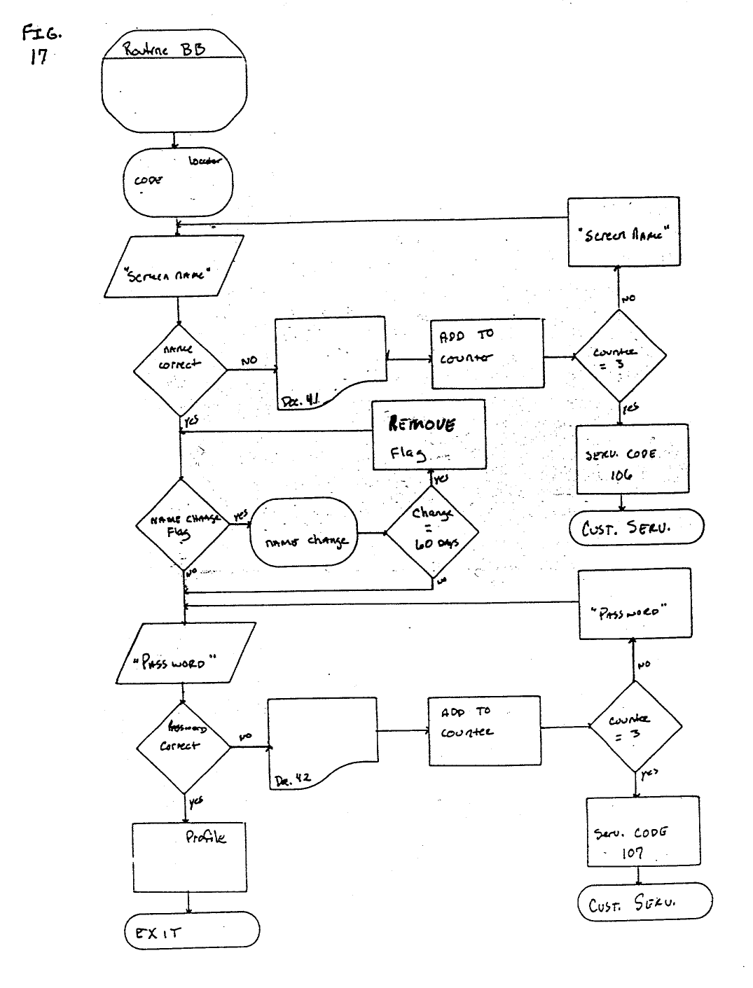

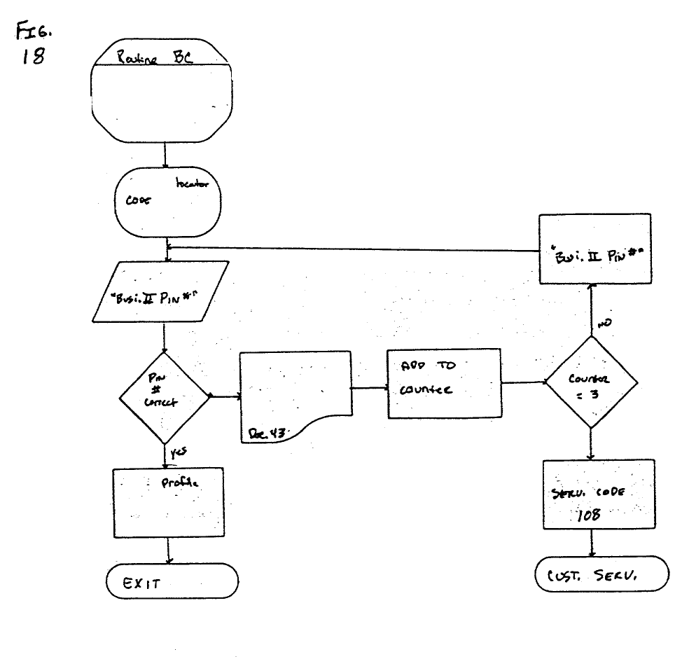

Referring to FIG. 12: The information in the ID profile (age, gender, color code and screen name) is provided to the partnered website. After providing the ID Profile to the partnered website, the subroutine determines whether the profile session is active. If the profile is in an “inactive” state, the subroutine activates the file. If the profile is already active, the history in the history cache (i.e., recently accessed partnered website activity) is directly written to the database at the gateway computer. The hand holding subroutine CA tracks the history of the user's profile. The program activates a history cache and adds the current information. The program now performs an operation to redirect the user back to the profile website. It does this by writing a front-end browser code telling the user's PC to perform routine CC, FIG. 15, when new URL is entered.

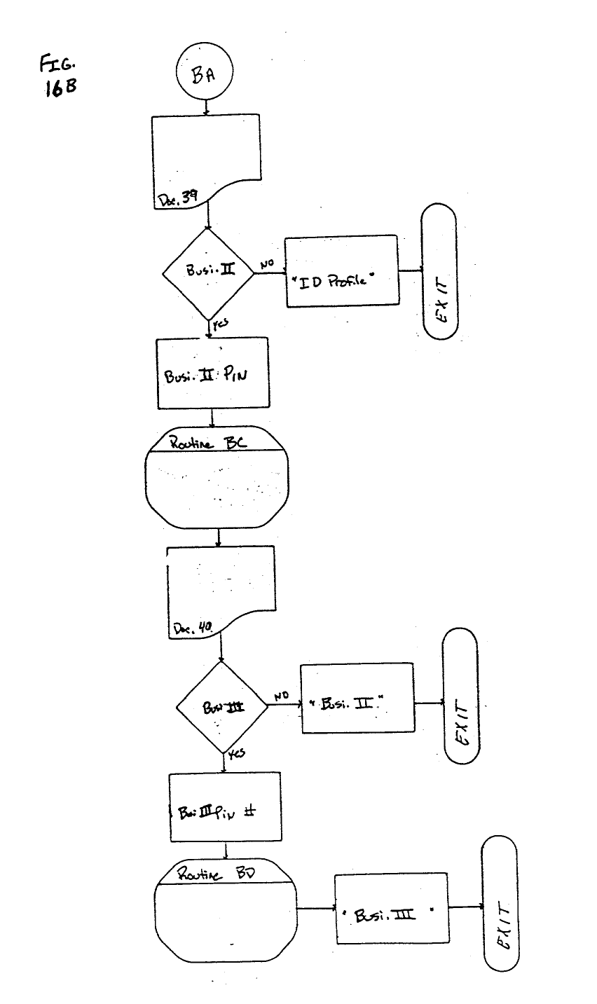

Referring to FIG. 12: If upon exiting the PIP the user's profile is a Business Level II Profile or Business Level III Profile then a subroutine (CB) is launched to select the fields in the profile(s) to share with the partnered website, as shown in FIG. 14. For example, a message displayed to the user may show the information in the user's business Level II and business Level III profiles (Document 35), as a series of checkboxes or toggle switches as well as the partnered website application and requirements. The user selects which of the fields to share with the partnered website, and upon submission, those fields are written to a cached output file which is sent to the website. The user is then prompted with a message such as “Finished with Information? Do you need more information from your Business Level II or Business Level III Profile? Yes_______ No________” (Document 36). If more information is needed, the user is displayed their profile information selection page again. If the user does not require more profile information, the business and profile caches are erased and the subroutine CB exits to the WIP and performs the subroutine CA described above.

Referring back to FIG. 12: The user is presented wit a “Want Another Website” document which states, “Would you like to go to another website? If you choose no, your profile will be deactivated. Yes_______ No______” (Document 34). If the user wishes to visit another website, a redirect subroutine (CC) FIG. 15 is launched. The redirect subroutine links to the gateway website upon detecting the entry of a website's new URL. The subroutine reads the new URL and compares it to a gateway database that contains a list of all websites that interact with the gateway computer system, i.e., all of the websites having the WIP licensed and installed. If the website is included in the interactive website database, the subroutine CC performs an operation which tells the new website a profile is coming. It does this by writing a back-end browser code on the users PC. The program then links the user to the new URL and exits the WIP, so that the user may execute another WIP at the new website.

If the website which the user entered is not in the interactive website database, the user is shown a messages such as “No Profile Site” which states, “This site does not offer profile use. If you wish to stay at this site, we will have to deactivate your profile. Do you want to stay? Yes_______ No______” (Document 37). If the user chooses to stay the program erases all caches (ID, Business Level II, Business Level III and history) and renames the file in the database as “inactive”. An exit thank you message is displayed such as “Thank you for choosing Verified Personal Profiles. Please visit our website if we can help you in the future” (Document 31). If the user decides to go to another website, the program adds the current information to the history cache and allows the user to enter the new URL. The program then runs a looping process of comparing new URL's to the interactive website database until the user either finds an interactive website or decides to stay at a non-interactive website. The Subroutine and WIP then end.

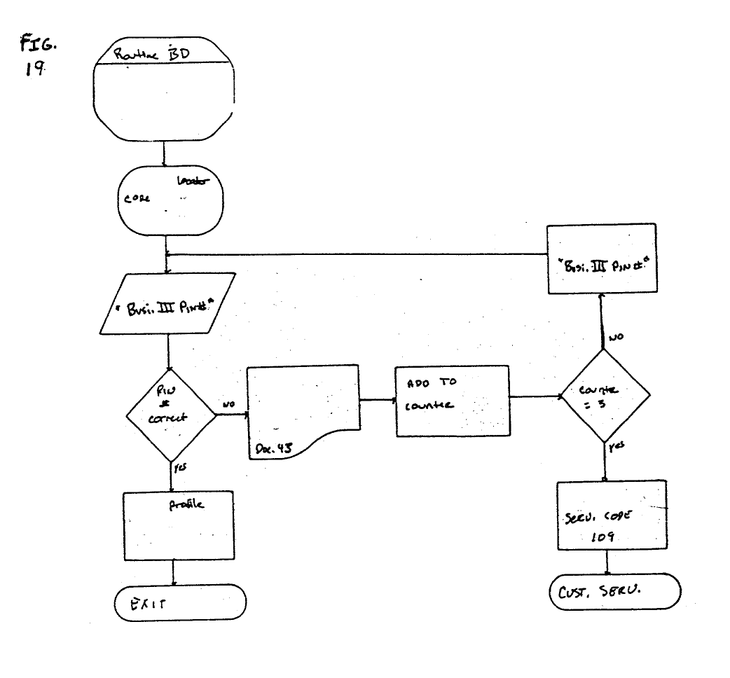

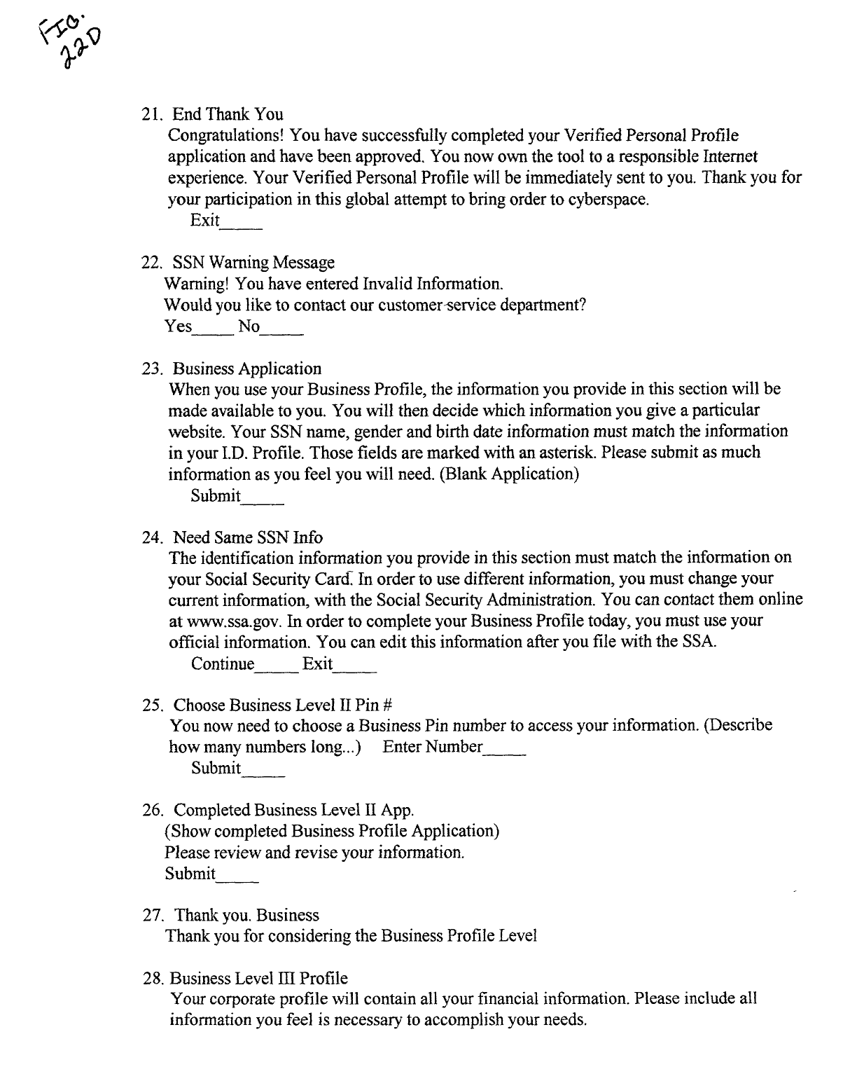

Referring now to FIGS. 16A-B: The Profile Interactive Program (PIP) resident at the gateway website, interacts with the website interactive program WIP and the user Profile CD via the CIP and PCIP. When the user starts a profile session with the PIP, the PIP first checks whether a profile session is already active. If the profile session is not active, the user is prompted to place the Profile CD in the CD-ROM using a message such as “Must Have CD. You must have an Identification Profile CD to activate this service. To continue, please insert your personal profile CD now. Submit_______ Exit_______” (Document 38). If the user does not insert a CD they are routed to the interactive website homepage and exit the PIP. After the user has inserted the CD, the PIP activates the CD Interactive Program CIP FIG. 20, which launches the PCIP to retrieve and validate the locator code from the CD.

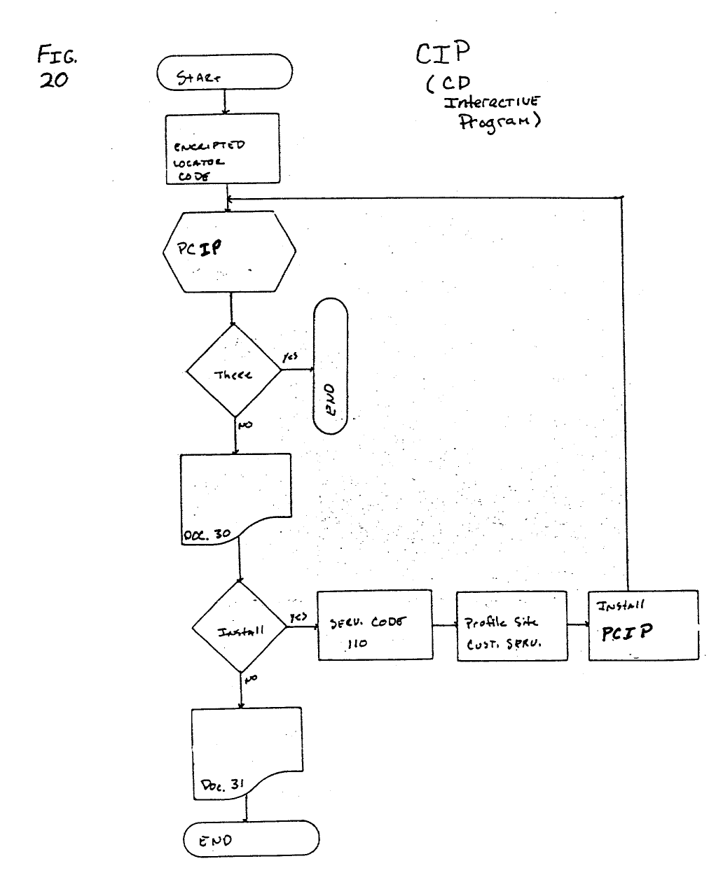

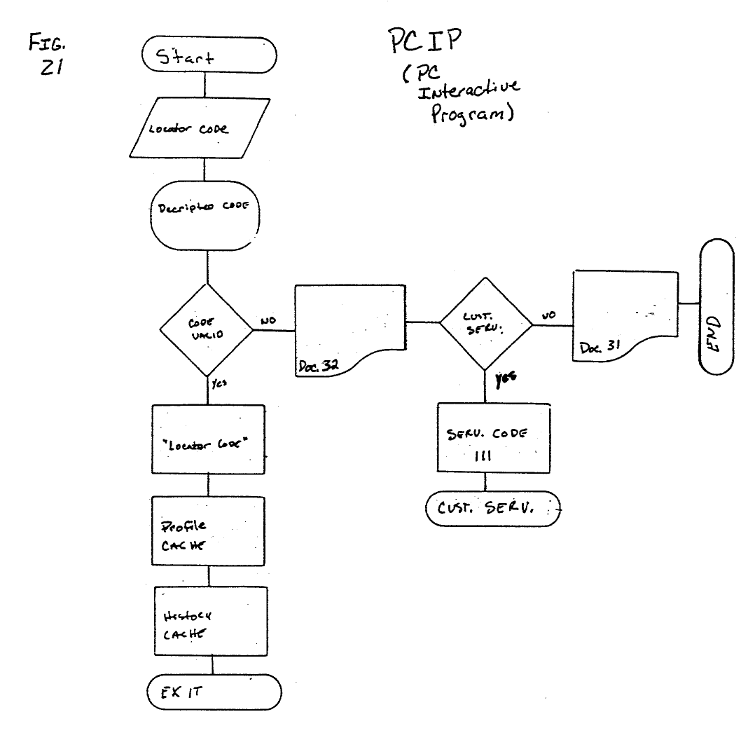

After the locator code from the CD has been retrieved, the PIP stores the code to maintain access to the profile for the profile session. The user is then prompted to enter their screen name and their password. After the locator code, screen name and password are entered, a subroutine (BB) is activated to retrieve and verify the user's ID Profile from the Profile database at the gateway website gateway computer as in FIG. 17. The subroutine BB retrieves the locator code stored by the CIP and locates the Profile in the database. The subroutine BB compares the screen name and password entered by the user to the screen name and password located in the profile database.

More specifically, the subroutine BB FIG. 17 compares the screen name entered by the user to the screen name located in the profile database. If the entered screen name does not match the database screen name a warning message is displayed stating for example “You have entered an invalid screen name. If you have forgotten your screen name, please return to the homepage for help. Retry______” (Document 41). Also, a counter initially set at 0 has 1 added to it. If the counter is less than 3, the user is again prompted to enter their screen name. If the counter reaches 3, a customer service code of 106 is appended to the profile session corresponding to “User entered invalid screen name 3 times” and the user is routed to the customer service area. If the entered screen name matches the screen name in the database (associated with the locator code), then the subroutine BB goes on to verify the user's password.

Preferably, during the subroutine BB, a date flag is attached to the user's screen name. This allows the user to carry a caption for aliases or formerly know as designation for a certain amount of time. If the screen name has changed a flag is appended to the file. The subroutine computes the number of days since the last name change. If that number is less than 60 days, for example, the flag remains with the screen name as well as the caption associated with the flag. However, if the number of days is equal to or greater than 60 days, then the flag and associated caption are removed from the profile screen name.

The subroutine BB compares the-password entered by the user to the password located in the profile database (associated with the retrieved locator code). If the entered password does not match database password a warning message is displayed stating for example “You have entered an invalid password. If you have forgotten your password, please return to the homepage for help. Retry______” (Document 42). Also, a counter initially set at 0 has 1 added to it. If the counter is less than 3, the user is again prompted to enter their password. If the counter reaches 3, a customer service code of 107 is appended to the profile session corresponding to “User entered invalid password 3 times” and the user is routed to the customer service area. If the entered password matches the password in the database, the user's profile is moved to output (activated) and the subroutine BB is exited, returning to the PIP.

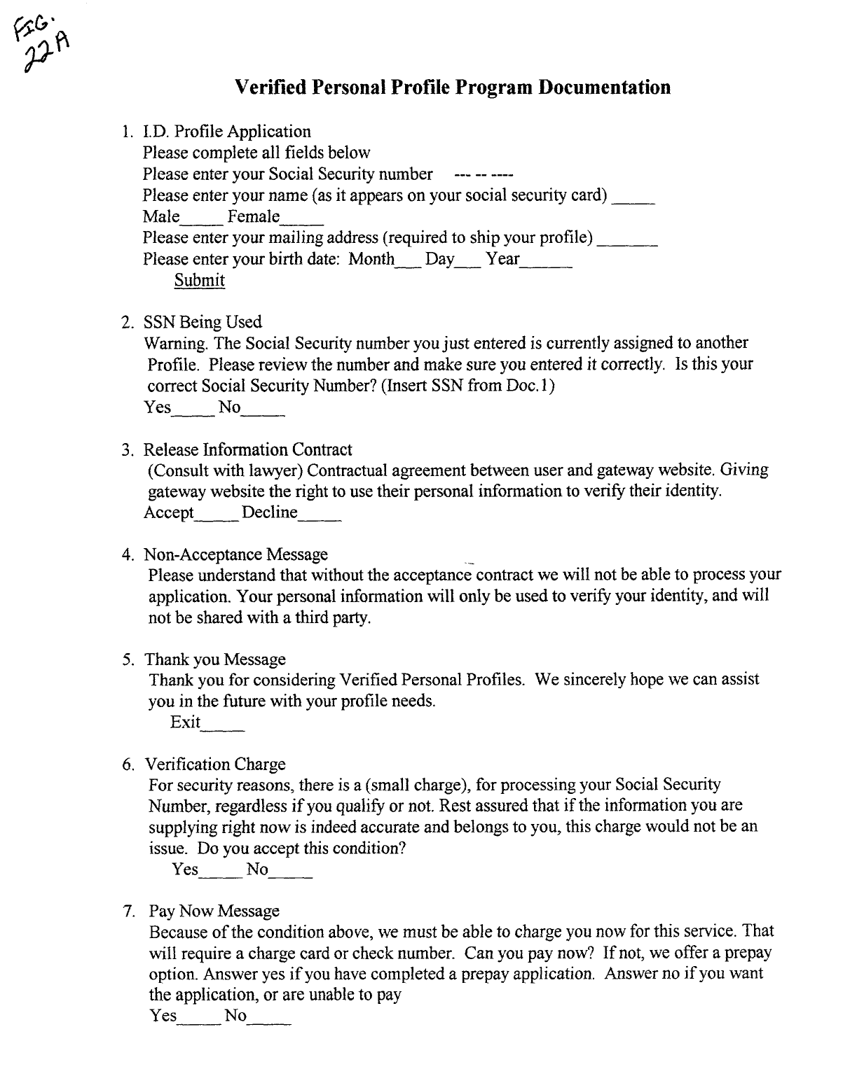

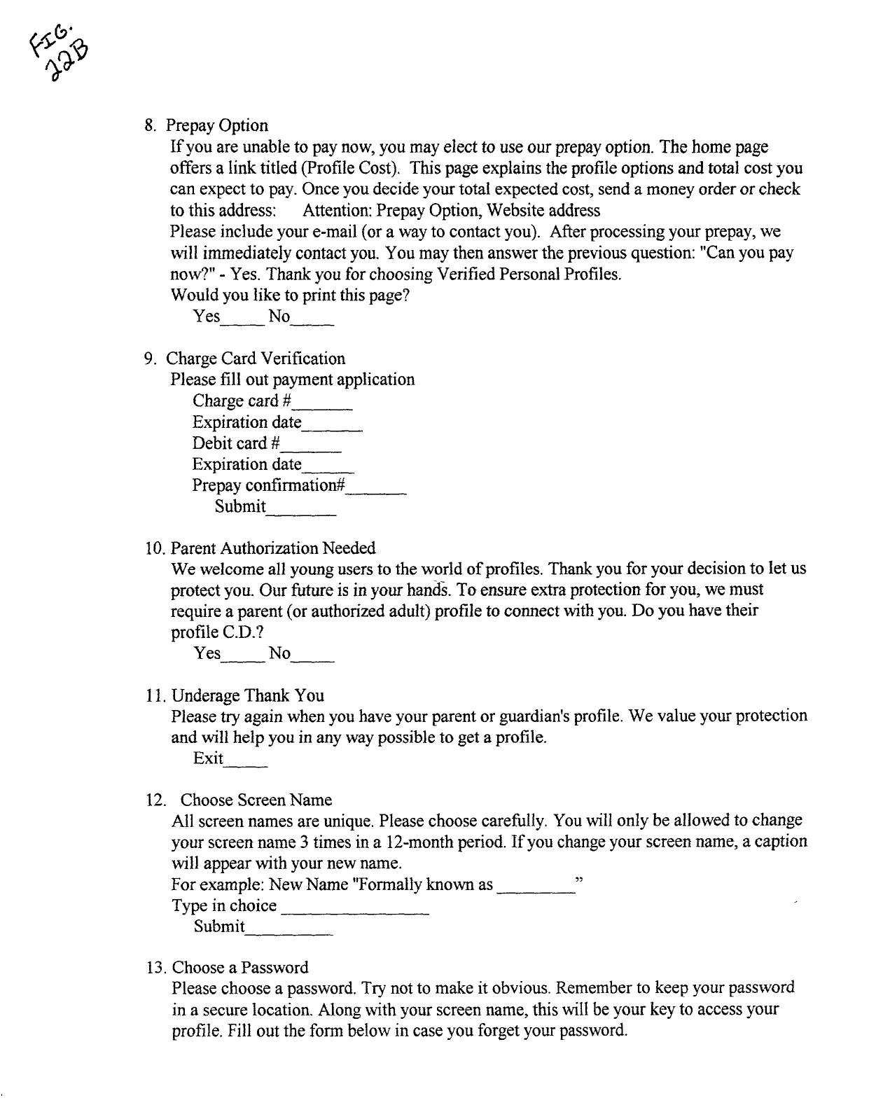

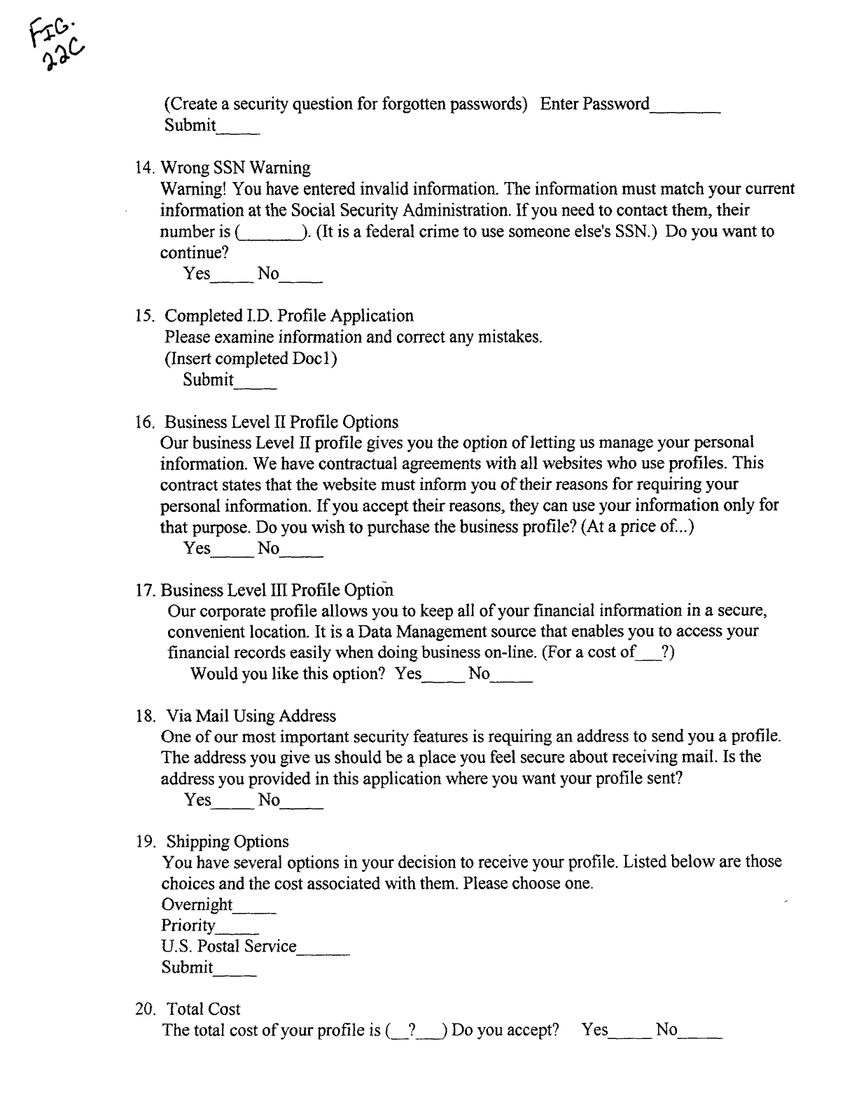

Referring to FIGS. 16B, 18 and 19: The PIP also verifies whether the user wants to activate their Business Level II Profile and/or Business Level II Profiles. After the profile is moved to an output file, the user is prompted to activate their business profile with a message such as “Do you need your Business Level II Profile Information for this website? Yes______ No_______” (Document 39). If the user does not want to access their business profile, the profile session is named an “ID Profile” session and the PIP is exited. If the user wishes to active their business profile, the user is prompted to enter the PIN number. A subroutine (BC) to retrieve the user business profile is then activated. The subroutine retrieves the locator code for the Profile and retrieves the business profile from that location in the Profile database. The subroutine then compares the PIN entered by the user to the PIN located in the Profile database. If the entered business PIN does not match database business PIN a warning message is displayed stating for example “You have entered an invalid PIN #, please return to the homepage for help” (Document 44). Also, a counter initially set at 0 has 1 added to it. If the counter is less than 3, the user is again prompted to enter their business PIN. If the counter reaches 3, a customer service code of 108 is appended to the profile session corresponding to “User entered invalid Business PIN 3 times” and the user is routed to the customer service area. If the entered business PIN matches the business PIN in the database (associated with the locator code), then the subroutine BC moves the Business Level II Profile to output and exits the subroutine and returning to the PIP.

After the Business Level II Profile is moved to an output file, the user is prompted to activate their Business Level III Profile with a message such as “Do you need your Business Level III Profile Information for this website? Yes ______ No ______” (Document 41). If the user does not want to access their business profile, the profile session is named a “Business Level II Profile” session and the PIP is exited. If the user wishes to activate their Business Level III Profile, the user is prompted to enter the business PIN number. A subroutine (BD) to retrieve the user business profile is then activated. The suboutine retrieves the locator code for the Profile and retrieves the business profile from that location in the Profile database. The subroutine then compares the PIN entered by the user to the PIN located in the Profile database. If the entered business PIN does not match database business PIN a warning message is displayed stating for example “You have entered an invalid PIN #, please return to the homepage for help”. Also, a counter initially set at 0 has 1 added to it. If the counter is less than 3, the user is again prompted to enter their business PIN. If the counter reaches 3, a customer service code of 109 is appended to the profile session corresponding to “User entered invalid Business Level III Profile PIN 3 times” and the user is routed to the customer service area. If the entered business PIN matches the business PIN in the database (associated with the locator code), then the subroutine BD moves the Business Level III Profile to output and exits the subroutine and returning to the PIP. After the Business Level III Profile is moved to an output file, the profile session is named a “Business Level III Profile” session and the PIP is exited.

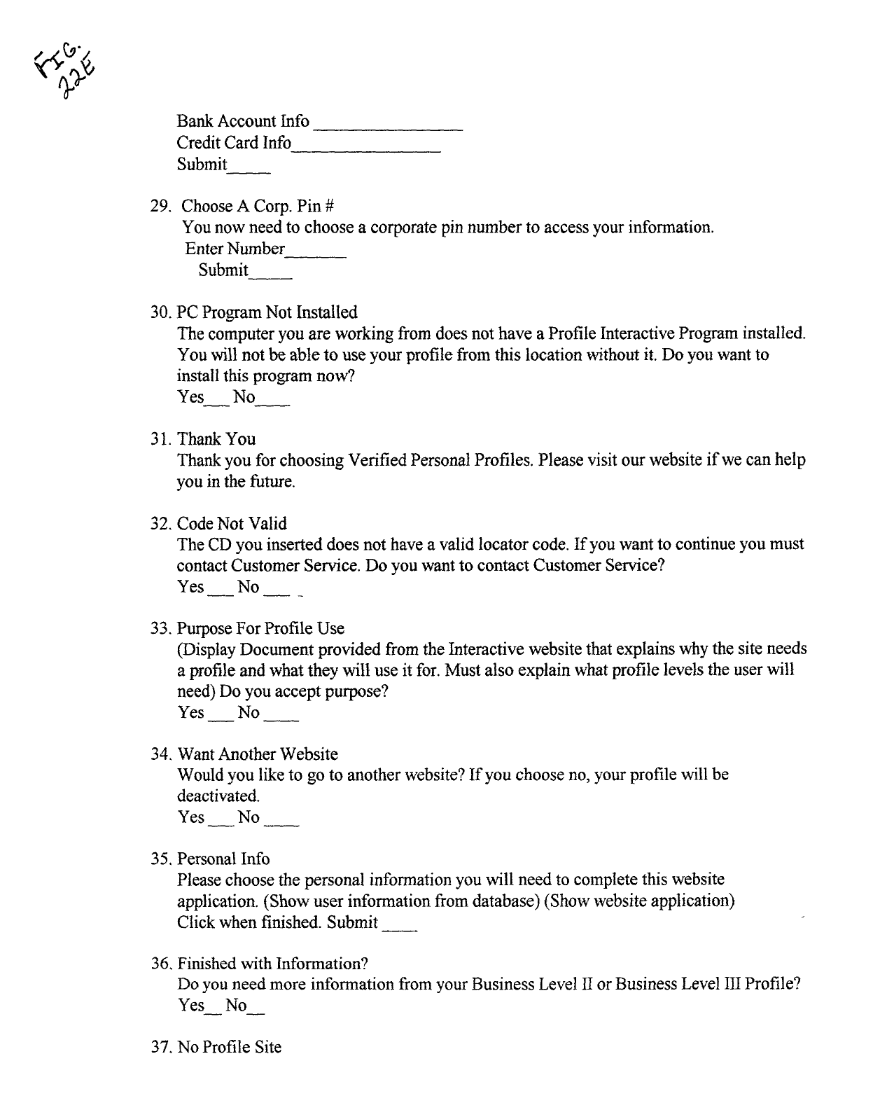

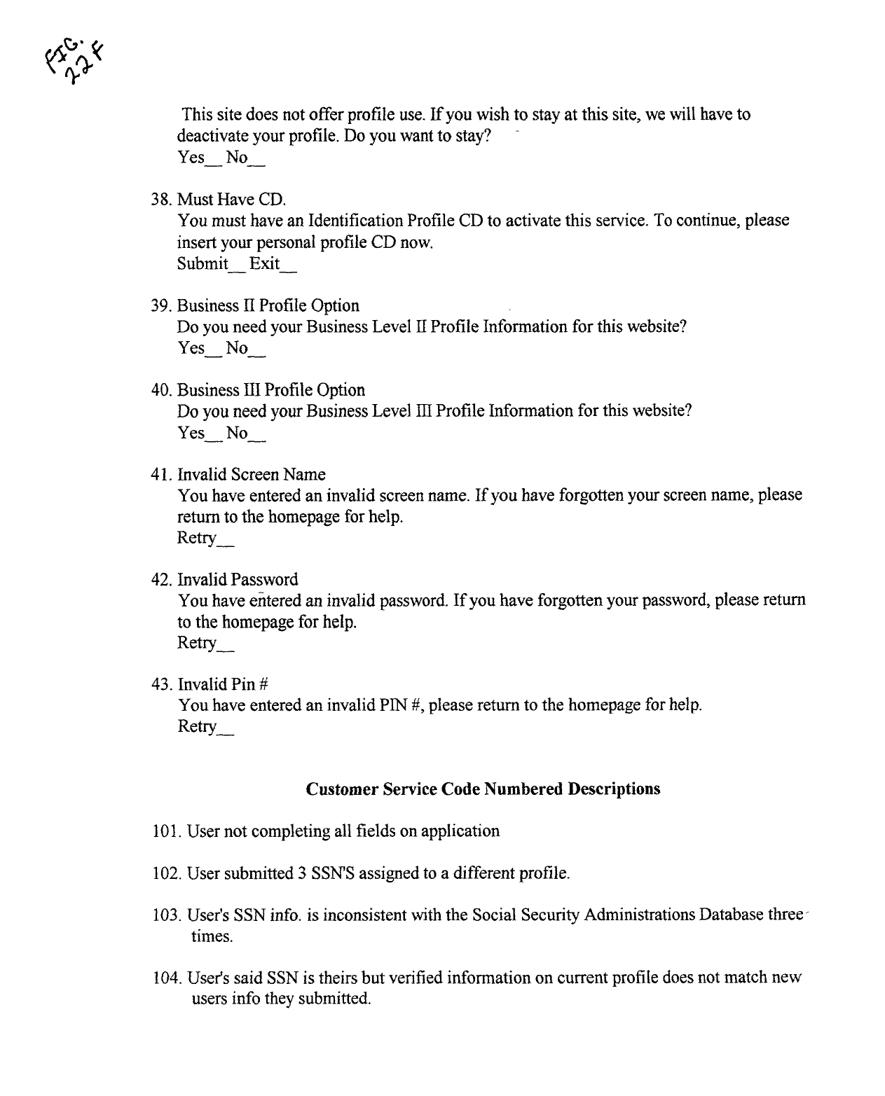

Referring to FIGS. 20 and 21: The CD containing their locator code and a program resident on the CD is read using a program resident on the user's PC. These programs are the CD Interactive Program (CIP) and the PC Interactive Program (PCIP). The user first places the Profile CD into the CD-ROM device. The CD-ROM reads the encrypted locator code from the CD and launches the PCIP. If the PCIP is not present on the user's hard drive, the CEP displays a message to the user such as: PC Program Not Installed. The computer you are working from does not have a PC Interactive Program installed. You will not be able to use your profile from this computer without it. Do you want to install this program now? Yes_______ No_______” (Document 30). If the user chooses not to install the PCIP a thank you message is displayed such as “Thank you for using Verified Personal Profiles. Please visit our site (or other site location) if we can help you in the future” (Document 31), and then they exit the CIP. If the user chooses to install the program, a customer service code of 110, corresponding to “User wants to install PCIP to current computer” is appended to their profile session, and the user is linked to the gateway website customer service area. From the gateway site, the user may download and install the PCIP. Once the PCIP is installed, When the CIP is executed, the PCIP will also launch.

Referring to FIG. 21: When the PCIP starts it reads the encrypted locator code that PCIP extracted from the user's Profile CD. With the user's PC connected to the gateway website, the PCIP decrypts the locator code and compares it to the code database at the gateway website. If the code is not valid, the PCIP will show the user a message such as “Code Not Valid. The CD you inserted does not have a valid locator code. If you want to continue you must contact Customer Service. Do you want to contact Customer Service? Yes______ No______” (Document 32). If the user wishes to contact Customer Service, a customer service code of 111 is appended to the profile session corresponding to “User's CD does not have a valid locator code” and the user is linked to the Customer Service area. If the user does not wish to contact Customer Service a thank you message is displayed such as “Thank you for using Verified Personal Profiles. Please visit our site (or other site location) if we can help you in the future” (Document 31), and then they exit the PCIP. If the locator code on the CD is valid, then the PCIP appends a code to the profile session corresponding to the session with a valid locator code, and activates the profile cache and the profile history cache. The PCIP then ends and allows the user to manage their profile using other programs (WIP and PIP) resident at the gateway website gateway computer and the interactive website.

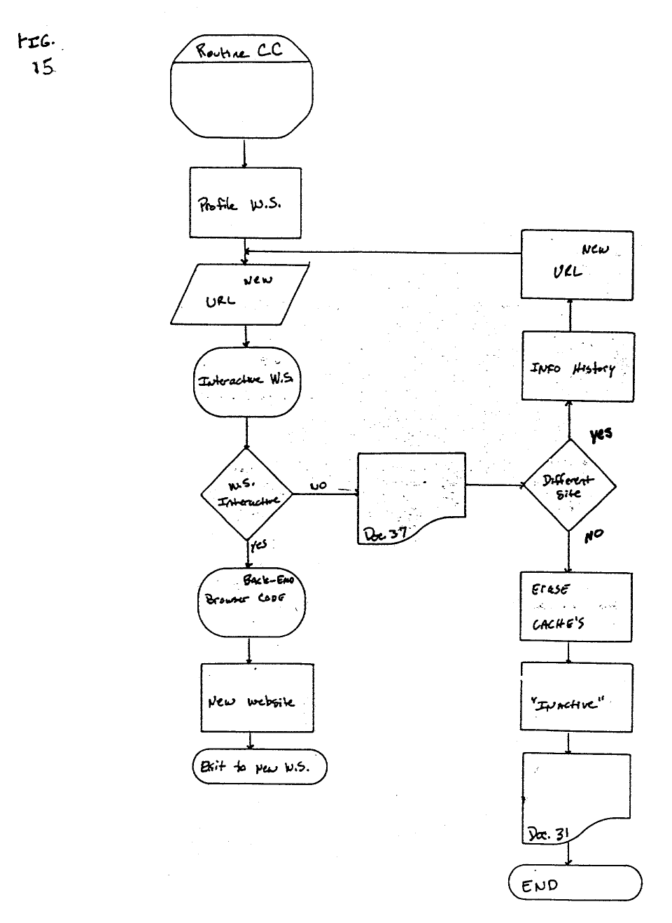

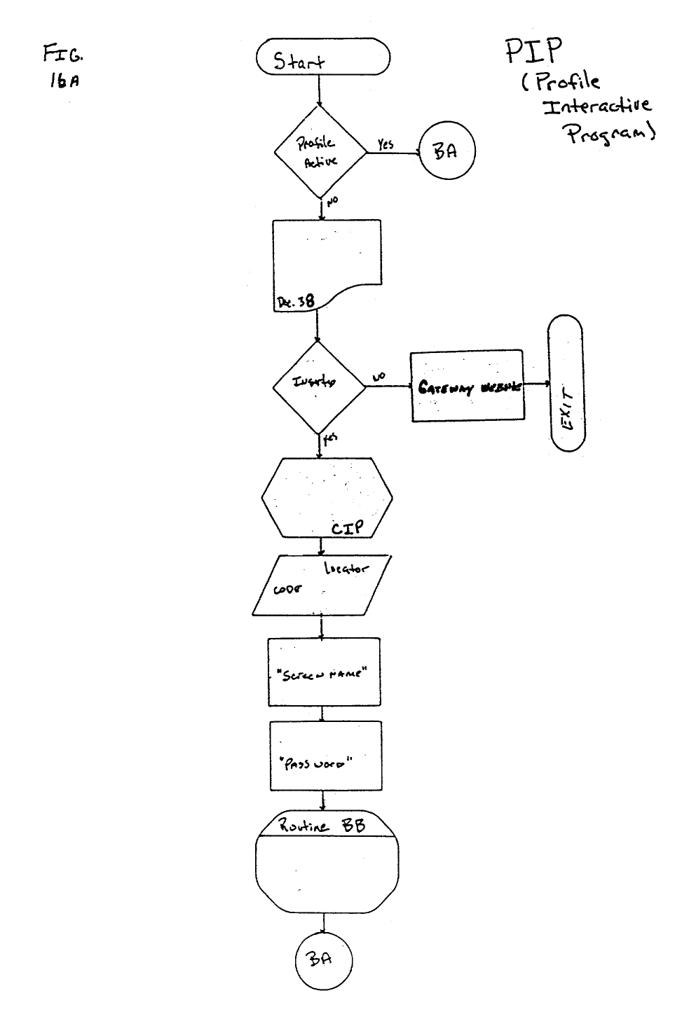

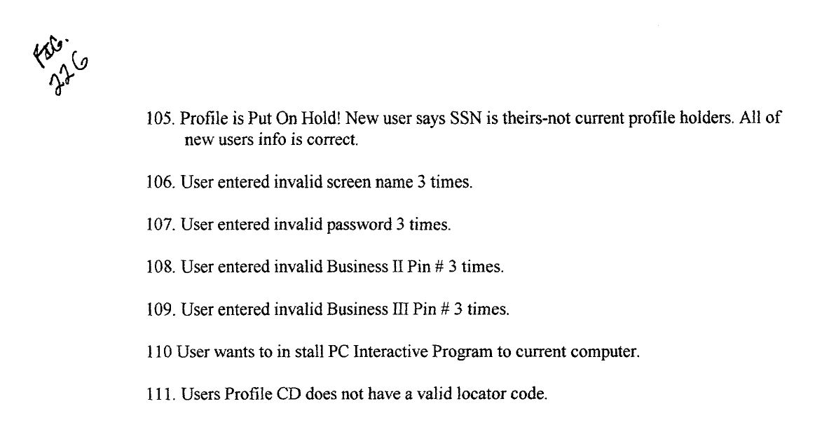

Referring to FIGS. 22A-22G. FIGS. 22A-22G shows a list of sample messages and customer service codes cross-referenced to the block diagrams of FIGS. 4A-21. Although these messages suffice for the preferred embodiment of the invention, any set of interactive questions that fulfill the interactive data entry and direction of the programs will suffice.

Other options that increase the functionality and security of the Profile database include getting further information from the social security database. For example, the Profile system will get a list of deceased people and delete those profiles, which will free up screen names as well as prevent user's from using a deceased person's profile.

Users can also have the option to search for names in the screen name database to see if the one they want is available. Users will be allowed to change their screen name, for example up to three times per year. If they change their screen name, a caption such as “formally known as” can be included to hold the user accountable for their actions.

Another option includes offering a service on the site for people who don't have a profile, to run their own or their children's SSN to see if anyone is using it. Also offered is the ability of the profiled user access to track the history of where there own or their child's profile has been.

Another option is to offer a link to a chat room we created that requires profiles to gain access. The gateway administration would retain the right to revoke or deny any profile at any time. A complaint procedure gives users the right to appeal decisions.

Cyberspace is currently a place where a person can pretend to be anyone they want, which has been an entertaining novelty in a new environment. The time is ripe to offer users the choice and protection of verified profiles. The current focus of security on the Internet is by concerned parents who do not want their children being exploited by unscrupulous adults. Profiles are a tool that can help eliminate the possibility of an older adult developing a relationship with an underage user. Through marketing we hope to create a grass roots movement among parents to require profiles in rooms their children visit.

Profiles will be used as identification, similar to a driver's license. Involvement in this service will be voluntary on the part of the user. Sponsorship attention will be directed at security companies and family oriented businesses. Partnerships will include heavy traffic websites who are age and sex sensitive. The initial focus will target users that benefit from authentic age and gender data. Age sensitive sites in those where by law a user must be 18 years old or older to enter rooms that promote gambling, pornographic, alcohol, tobacco, firearm and explosive material. Gender sensitive sites include those targeted at gays and lesbians. This group is a specific target market that would benefit from gender data. Research shows that 85% of users seeking relationships on the Internet are from this group. Heterosexual men pretending to be lesbians continually target lesbians. A profile containing the users gender will eliminate time consuming research and frustration for this group.

The user will have the option of allowing partnered websites to be given their accurate personal information. Through partnerships and marketing, websites will begin to create or modify rooms that can be entered with a profile. Interactive sites will be required to use software designed to access our database. Collected data will include a history of every room a particular profile has entered, generating revenue through data sells. A large database of users will enable cross checking of social security numbers to be an attractive incentive for new customers.

Using the techniques described above, there is a high level of assurance that information and business transactions will be made securely and accurately. The redundant security features provided in the programs allow for a user to feel secure about other identities, while having the security of protecting their own identity from interception and misappropriation. As new security features become available, each one will be evaluated for its utility in conjunction with the Profiles database to protect the users'names and SSN's.

While the above description contains much specificity, these should not be construed as limitations on the scope of the invention, but rather as exemplification of preferred embodiments thereof.

References Cited

| | | | |
|---|---|---|---|
| 4661658 | April 1987 | Matyas | 380/23. |
| 4754487 | June 1988 | Newmuis | 382/2. |
| 4879747 | November 1989 | Leighton et al. | 380/23. |
| 4893338 | January 1990 | Pastor | 380/25. |
| 4991205 | February 1991 | Lemelson | 235/382. |
| 4993068 | February 1991 | Piosenka et al. | 380/23. |
| 5097504 | March 1992 | Camion et al. | 380/23. |
| 5191613 | March 1993 | Granziano et al. | 380/25. |
| 5214702 | May 1993 | Fischer. | 380/23. |
| 5235165 | August 1993 | Sukegawa et al. | 380/23. |
| 5311594 | May 1994 | Penzias. | 358/479. |
| 5327497 | July 1994 | Mooney et al. | 380/51. |
| 5420926 | May 1995 | Low et al. | |
| 5436972 | July 1995 | Fischer | 380/25. |
| 5442342 | August 1995 | Kung. | |
| 5533123 | July 1996 | Force et al. | |
| 5577120 | November 1996 | Penzias. | |
| 5638446 | June 1997 | Rubin. | |
| 5655077 | August 1997 | Jones et al. | |
| 5659616 | August 1997 | Sudia. | |
| 5668876 | September 1997 | Falk et al. | 380/25. |
| 5677955 | October 1997 | Doggett et al. | |
| 5684950 | November 1997 | Dare et al. | |
| 5684951 | November 1997 | Goldman et al. | |
| 5689638 | November 1997 | Sadovsky. | |
| 5706427 | January 1998 | Tabuki. | |
| 5712914 | January 1998 | Aucsmith et al. | |
| 5748738 | May 1998 | Bisbee et al. | 380/25. |
| 5771291 | June 1998 | Newton et al. | 380/25. |
| 5818936 | October 1998 | Mashayekhi. | |
| 5841970 | November 1998 | Tabuki. | |
| 5845070 | December 1998 | Ikudome. | |
| 5864622 | January 1999 | Marcus | 380/23. |
| 5864665 | January 1999 | Tran | 395/187. |
| 5872917 | February 1999 | Hellman. | |
| 5875296 | February 1999 | Shi et al. | |
| 5893098 | April 1999 | Peters et al. | 707/10. |
| 5987134 | November 1999 | Shin et al. | 380/25. |
| 5987232 | November 1999 | Tabuki | 395/187. |
| 6006333 | December 1999 | Nielsen | 713/202. |
| 6026491 | February 2000 | Hiles | 713/202. |
| 6072870 | Jun. 6, 2000 | Nguyen, et al. | 705/79 |
| 6260111 | Jun. 10, 2001 | Craig, et al. | 711/115 |
| 6263447 | Jul. 17, 2001 | French, et al. | 713/201 |
| 6282658 | Aug. 28, 2001 | French, et al. | 713/201 |
| 6321333 | Nov. 20, 2001 | Murray | 713/156 |
| 6321339 | Nov. 20, 2001 | French, et al. | 713/201 |

What is claimed is:

1. A system and method to provide a service that interacts with personal and commercial computer users of the global network, which compromises the Internet, with preprocessing to generate and authenticate and verify a VPP (Verified Personal Profile) for a first computer user and which is authored by a first computer user via a gateway computer system, which compromises the Verified Personal Profile website.

2. The method of claim 1, wherein a computer system provides a service that interacts with personal and commercial computer users of the global network, said method comprising:
a) A gateway computer system, which a first computer user may use to generate and store the first computer users VPP;
b) A gateway computer system, which authenticates the accurate VPP of the first computer user; to other users and websites on the global network;
c) A gateway computer system, which verifies the accurate VPP to other users and websites on the global network;
d) A gateway computer system, which verifies the accurate VPP of other computer users to a first computer user;
e) A gateway computer system, which verifies the VPP as being from an authentic source and without risking the exposure of the information to interception by third parties that have access to the network with a partnered interactive website;
f) A gateway computer system may allow other users to cross check their SSN against the VPP SSN database;
g) A gateway computer system may produce the history of the first computer user VPP to the first computer user for security reasons.

3. The method of claim 1, wherein a first computer user authors a VPP, said method comprising:
a) A software program PPP (Purchase Profile Program) which uses preprocessing to authenticate the first computer user VPP;
b) A first computer user is presented with a hierarchy of queries designed to ensure the identity of the first computer user and prevent fraud, false negatives and other undesirable results;
c) A first computer user inputs text in character form that consist of social security number information, name information, gender information, address information, birth date information, financial information and other information;
d) A first computer user may select differing Levels of a VPP.

4. The method of claim 3 (a), wherein a software program PPP (Purchase Profile Program) which uses preprocessing to authenticate and verify the first computer user VPP, said method comprising:
a) A software program PPP, which uses a data routine to ensure all data fields are correct and complete;
b) A software program PPP, which uses a counter routine to eliminate looping programs designed to locate unused SSN's (Social Security Number);
c) A software program PPP, which activates a software program subroutine AB (SSN crosschecking routine), which utilizes a VPP SSN database, to compare the first computer users SSN to other VPP users SSN's and SSN's belonging to deceased individuals;
d) A software program PPP, which activates a software program subroutine AC (Misuse of SSN), which determines when the VPP SSN data matches the VPP SSN data in the VPP SSN database;
e) A software program PPP, which uses a pre-pay routine to eliminate looping programs designed to locate unused SSN's;
f) A software program PPP which, assigns a code color to a first computer user depending on the users age which, a first computer users age may define restrictions put on such profiles;
g) A software program PPP, which activates a software program subroutine AD (Verify Profile Information), which compares the first computer users VPP information to a database which contains the accurate SSN information pertaining to the first computer users Government issued SSN;
h) A software program PPP, which assigns a unique screen name and password to the authorized first computer user;
i) A software program PPP, which assigns a VPP to the authorized first computer user and may award differing Levels of a VPP;
j) A software program PPP, which adds the authorized VPP to a VPP SSN database.

5. The method of claim 4 (i), wherein a software program PPP, which assigns a VPP to the authorized first computer user and may award differing Levels of a VPP, said method comprising:
a) A software program subroutine AE (Create ID Profile), which generates a Level I VPP;
b) A software program subroutine AF (Create Business Level II Profile) which, generates a Level II VPP;
c) A software program subroutine AG (Create Business Level III Profile) which, generates a Level III VPP;
d) A other Level VPP would include, but not limited to, other VPP group information such as a business purchasing department employee identification.

6. The method of claim 5(a), wherein a software program subroutine AE (Create ID Profile), which generates a Level I VPP, said method comprising:
a) A Level I VPP comprises a first computer users authenticated gender, age, code color and unique screen name;
b) A software program subroutine AE, which generates a locator code and assigns a password to the location.

7. The method of claim 5(b), wherein a software program subroutine AF (Create Business Level II Profile), which generates a Level II VPP, said method comprising:
a) A Level II VPP comprises a first computer users authenticated personal identification information, such as; name, address, phone number, e-mail address and other information;
b) A software program subroutine AF, which uses a comparison routine to ensure the first computer users Level II VPP information matches the first computer users Level II VPP authenticated information;
c) A software program subroutine AF, which assigns a Level II VPP pin number to the Level II VPP.

8. The method of claim 5(c), wherein a software program subroutine AF (Create Business Level III Profile), which generates a Level III VPP, said method comprising:
a) A Level III VPP comprises a first computer users financial and other information;
b) A software program subroutine AG, which assigns a Level III VPP pin number to the Level III VPP.

9. A system and method for producing the exchange of such secure identification, a VPP (Verified Personal Profile) which in one embodiment a first computer users unique identification information, locator code, which may be encrypted, is stored on an identification CD (Compact Disk) and validated to permit access to a gateway computer system which compromises the Verified Personal Profile website via the Internet.

10. The method of claim 9, wherein a system and method for producing the exchange of such secure identification, a VPP (Verified Personal Profile), said method comprising:
a) A first computer users unique identification information, locator code, is encrypted on a CD (Compact Disk) and sent to the first computer user via the first computer users address;
b) A CD (Compact Disk) contains a software program CIP (CD Interactive Program) that activates a software program PCIP (PC Interactive Program) embedded on a first computer users computer system;
c) A software program PCIP embedded on a first computer users computer system relays the encrypted unique identification information, locator code to a gateway computer system which decrypts the received encrypted unique identification information, locator code;
d) A gateway computer system verifies the unique identification information, locator code, and performs first computer user authentication on the basis of the decrypted unique identification information, locator code;
e) A gateway computer system uses the unique identification information, locator code, to access and retrieve a first computer users VPP;
f) When the first computer user is authenticated and found registered, a gateway computer system provides a service requested by the first computer to a partnered interactive website content server.

11. A system and method to provide a service that interacts with personal and commercial computer users of global networks, which comprises the Internet, with preprocessing to exchange, a VPP for a first computer user with a partnered website, using a gateway computer system, which comprises the Verified Personal Profile website.

12. The method of claim 11, wherein a computer system provides a service that interacts with personal and commercial computer users of the global network, said method comprising:
a) A gateway computer system, which a first computer user may use to transmit and exchange the first computer users VPP;
b) A gateway computer system, which verifies the accurate VPP to other users and websites on the global network;
c) A gateway computer system, which verifies the accurate VPP of other computer users to a first computer user;
d) A gateway computer system, which has the responsibility to verify the VPP as being from an authentic source and without risking the exposure of the information to interception by third parties that have access to the network with a partnered interactive website;
e) A first computer user may authorize a gateway computer system to make data available to conduct a transaction, access data or avail themselves of other resources or processing only by those approved by the first computer user;
f) A gateway computer system receives contractual agreements with a partnered interactive website.

13. The method of claim 12(f), wherein a gateway computer system receives contractual agreements with a partnered interactive website, said method comprising:
a) A gateway computer system receives contractual agreements with a partnered interactive website which agrees to use a VPP only for a stated purpose;
b) A gateway computer system receives contractual agreements with a partnered interactive website which agrees to use the OPT-IN method for all VPP users;
c) A gateway computer system provides partnered interactive websites with a software program WIP (Website Interactive Program).

14. The method of claim 13(c), wherein a gateway computer system provides partnered interactive websites with a software program WIP (Website Interactive Program), said method comprising:
a) A software program WIP links to the gateway computer system and activates a software program PIP (Profile Interactive Program);
b) A software program WIP activates a software program subroutine CA (Redirect) when the first computer user declines the interactive websites stated purpose for the use of the first computer users VPP;
c) A software program WIP links to the gateway computer system and activates a software program subroutine CB (Give Info To Website) when any Level VPP other than a Level I VPP is requested;
d) A software program WIP links to the gateway computer system and activates a software program subroutine CC (Hand Holding Routine) when the first computer user request a Level I VPP.

15. The method of claim 14(a), wherein a software program WIP activates a software program PIP (Profile Interactive Program), said method comprising:
a) A software program PIP determines if a VPP is not active;
b) A software program PIP determines if a VPP is active.

16. The method of claim 14(b), wherein when the first computer user declines the stated purpose for the use of the VPP, a software program WIP activates a software program subroutine CA (Redirect), said method comprising:
a) A software program subroutine CA links to the gateway computer system;
b) A software program subroutine CA determines if a new URL belongs to a partnered interactive website by comparing the new URL to a Interactive Website database;
c) A software program subroutine CA writes a back-end browser code to inform the new URL website that the first computer user has a VPP and links the first computer user to the new URL website when the new URL belongs to a interactive website;
d) A software program subroutine CA allows the first computer user to choose a different URL or deactivate their VPP when the new URL does not belong to a interactive website.

17. The method of claim 14(c), wherein a software program WIP activates a software program subroutine CB (Give Info To Website), said method comprising:
a) A software program subroutine CB exchanges the first computer users authorized Level II VPP with the partnered interactive website;
b) A software program subroutine CB exchanges the first computer users authorized Level III VPP with the partnered interactive website;
c) A software program subroutine may exchange the first computer users other Level VPP with the partnered interactive website.

18. The method of claim 14(d), wherein when a Level I VPP is requested by the first computer user, a software program WIP activates a software program subroutine CC (Hand Holding Routine), said method comprising:
a) A software program subroutine CC, authorizes a Level I VPP and exchanges the first computer users Level I VPP with the partnered interactive website;
b) A software program subroutine CC moves the previously stored history of the first computer user to a previous history database used to track the first computer users activity when the VPP is active;
c) A software program subroutine CC makes the VPP active when the VPP is not active;
d) A software program subroutine CC moves the first computer users history to a current history database used to track the first computer users activity;
e) A software program subroutine CC writes a front-end browser code to redirect the first computer users VPP to the gateway computer system when a new URL is requested.

19. The method of claim 15(a), wherein a software program PIP (Profile Interactive Program) determines if a VPP is not active, said method comprising:
a) A software program PIP activates a software program CIP (CD Interactive Program);
b) A software program PIP requires a Level I VPP password and screen name to authorize the activation of a software program subroutine BB (Retrieve ID Profile);
c) A software program PIP activates a software program subroutine BB (Retrieve ID Profile) when authorized.

20. The method of claim 15(b), wherein a software program PIP (Profile Interactive Program) determines if a VPP is active, said method comprising:
a) A software program PIP requires a Level II VPP pin number to authorize the activation of a software program subroutine BC (Retrieve Level II Profile);
b) A software program PIP activates a software program subroutine BC (Retrieve Level II Profile) when authorized;
c) A software program PIP requires a Level III VPP pin number to authorize the activation of a software program subroutine BD (Retrieve Level III Profile);
d) A software program PIP activates a software program subroutine BD (Retrieve Level III Profile) when authorized;
e) A software program may authorize a other Level VPP.
